(19) United States
(12) Patent Application Publication
(10) Pub. No.: US 2013/0180857 A1
(43) Pub. Date: Jul. 18, 2013

(54) EcoFloc Advanced Electro-coagulation Liquid Waste Treatment System and Process

(71) Applicants: Tim Heffernan, Indianapolis, IN (US); Bruce REA, Connersville, IN (US)

(72) Inventors: Tim Heffernan, Indianapolis, IN (US); Bruce REA, Connersville, IN (US)

(21) Appl. No.: 13/735,673

(22) Filed: Jan. 7, 2013

Related U.S. Application Data
(60) Provisional application No. 61/584,361, filed on Jan. 9, 2012.

(51) Int. Cl. C02F 1/463

(52) U.S. Cl. CPC C02F 1/463
USPC 204/571; 204/660

(57) ABSTRACT

An electro-coagulation system to convert impurities and dissolved metal contaminants to suspended particles where upon associated dissolved gases help the suspended particles to rise to the surface and facilitate the contaminants to be removed. The system and process, known as Eco-Floc, are used for the treatment of various types of liquid streams by electrolysis for removal of undesirable substances from a treatment stream. The unique features of the electrolysis system permit a continuous cleaning of the electrode plates by moving, non-conductive scrapers located between electrodes in order that the movement of the scrapers can clean each electrode. The system also has full electrical controls to “tune in” power for the removal of specific impurities. The sacrificial anodes are easily replaced. The applications of Eco-Floc anticipate a plethora of applications and adapts well both to existing operations and new installations.

### CROSS-REFERENCE TO RELATED APPLICATIONS

This application claims the benefit of Provisional Patent Application Ser. No. 61/584,361 filed Jan. 9, 2012 by Tim Heffernan and Bruce Rea entitled “Eco-Floc Advanced Electro-coagulation Liquid Waste Treatment System and Process”.

### FIELD OF INVENTION

This invention is the Eco-Floc Advanced Electro-coagulation Liquid Waste Treatment System and Process. The invention relates to a process for removing organics, particulates and dissolved metal contaminates from water, sewage and/or waste fluids by electrolysis or electrical chemistry. More particularity, the invention utilizes an electro-coagulation process to convert the impurities and dissolved metal contaminates to suspended particles where upon the dissolved gases help a portion of the suspended particles rise to the waste fluid surface to facilitate the contaminates to be removed or separable. The remaining portion of suspended particles precipitate, sinking to the bottom of the unit where they can be removed or separated. The system and process are used for the treatment of various types of liquid streams by electrolysis for the removal of undesirable substances from a treatment stream. Particularly they are for cleaning the waste water by utilizing an electro-coagulation process to change the particle from in solution to a particle in suspension which can be flocculated and separated from the water.

The Eco-Floc Advanced Electro-coagulation Liquid Waste Treatment System is a continuous cleaning electro-coagulation system developed by Enviro Solve Technologies. It utilizes moving non-conductive scrapers located between electrodes so that the movement of the scrapers can clean each electrode. The system also has full electrical controls to “tune in” the removal of specific impurities. The sacrificial anodes (electrode plates) are easily removed and replaced. The applications of the Eco-Floc system and associated process anticipate a plethora of materials and applications and adapts well both to existing operations as well as entirely new installations.

The purpose and utility of the Eco-Floc system provides for the separation of solids, suspended and to a lesser degree dissolved, from challenging liquid wastes. The system and process achieve outstanding separation and disinfection through the creation of electrically induced physical and chemical reactions in-situ, creating clear, pathogen-free water and hydrophobic solids that can be readily removed through any traditional means of physical separation. The Eco-Floc system is self-cleaning and applicable to a wide array of liquid wastes ranging from raw animal wastes from confined feeding operations, to industrial wastes containing significant dissolved sources of biochemical oxygen demand (BOD). It is believed that the system is the first automatic mechanical self-cleaning electro-coagulation system combining state of the art electrical control technology with a heavy duty, robust industrial strength mechanical unit designed for a wide variety of new wastewater treatment applications.

### FEDERALLY SPONSORED RESEARCH

None.

### SEQUENCE LISTING OR PROGRAM

None.

### BACKGROUND

### Field of Invention and Prior Art

### A. Background and Problem Addressed

Treatment of wastewater by electro-coagulation (EC) was practiced over 100 years and for most of the 20th century with limited success and popularity. Although it had been applied in waste water treatment, the lack of true scientific understanding of the complex chemical and physical processes involved had heretofore limited applications. While it was known that the purification of waste streams, and in particular the coagulation of contaminants without the need for addition of chemicals, could be accomplished through electrolytic treatment in a process called electro-coagulation, the wide range of contaminants, varying contaminant concentrations and large and variable volumes of wastewater in the industrial waste streams generally discouraged its use. In addition, the limitations (in terms of size and cost) of the needed power supplies had curbed large scale applications and hindered progress. These limitations coupled with the dissuasion by powerful manufacturers of chemicals have, until now, restricted the market penetration of this effective and environmentally friendly non-chemical procedure. Even systems that were able to overcome these problems often had other problems such as high labor cost (batch and dump methods); large areas (equipment footprints) necessary for increased residence time, and high capital costs due to electrical power and maintenance (on-line electrical systems); and low efficiency (dilution with non-conductive materials). Other systems suffered from design problems such as not accounting for the production of generated gases or the buildup of impurities onto the working electrodes, or creating an electrolytic cell that is too complex and which cannot be easily maintained. However with new technologies, especially the reduction of electricity requirements and the smaller size of the needed power supplies, electro-coagulation systems are now becoming a viable option for water treatment plants and industrial processes worldwide. The Eco-Floc electro-coagulation system and process delivers better-processed, enriched water waste streams in a robust and reliable equipment package.

The need for clean water is particularly critical in developing countries. Rivers, canals, estuaries and other water bodies are being constantly polluted due to indiscriminate discharge of industrial effluents and natural processes. Highly developed countries are also experiencing a critical need for wastewater cleaning because of an ever-increasing population, urbanization and climatic changes. Both the treatment of wastewater prior to discharge and the reuse of wastewater have become necessities. There is an urgent need to develop innovative, more effective and inexpensive techniques for treatment of wastewater.

A wide range of wastewater treatment techniques are known which includes biological processes for nitrification, denitrification and phosphorus removal, and a range of physical-chemical processes that require chemical addition. Some of the commonly used physical-chemical treatment processes are filtration, air stripping, ion exchange, chemical precipitation, chemical oxidation, carbon adsorption, ultrafiltration, reverse osmosis, electro-dialysis, volatilization, and gas stripping.

### B. The Technology of Electro-Coagulation

Electro-coagulation is the process of passing electric current through a liquid. It is a process by which electrolysis is combined with precipitation and flocculation to remove contaminants from wastewater. The electric current (voltage) provides the electromotive force required to drive the chemical reactions. The reactor utilized in the process contains a series of substantially parallel electrolytic plates (or electrodes—anodes and cathodes) through which the wastewater to be treated travels, often in a serpentine path, while the wastewater is being exposed to a strong electric field or voltage. Electro-coagulation is a surface reaction. The surface area within the reaction chamber (or zone) along with the power determines the capacity of the system to treat the wastewater. Electro-coagulation is an electro-chemical process that simultaneously removes heavy metals, suspended solids, emulsified organics and many other contaminants from water using electricity instead of expensive chemical reagents. The process uses electricity and sacrificial plates (the anodes) to combine with contaminants in a waste stream, producing insoluble oxides and hydroxides—i.e. flocculants or flocs—that are easily separated from the clear water.

The mechanism of electro-coagulation has been the subject of continual technical and industrial review. It is generally accepted that coagulation is brought about primarily by the reduction of the net surface charge to a point where the colloidal particles, previously stabilized by electrostatic repulsion, can approach closely enough for the Van Der Waals forces to hold them together and allow aggregation. The reduction of the surface charge is a consequence of the decrease of the repulsive potential of the electrical double layer by the presence of an electrolyte having opposite charge. In the electro-coagulation process, the coagulant is generated in situ (in its natural or original place) by electrolytic oxidation of an appropriate anode material. In this process, charged ionic species—metals or otherwise—are removed from wastewater by allowing it to react with an ion having an opposite charge, or with floc of metallic hydroxides generated within the effluent.

So re-stated, electro-coagulation in general is the process of destabilizing suspended, emulsified or dissolved contaminants in an aqueous medium by introducing an electrical current into the medium. The electrical current provides the electromotive force to drive the chemical reactions. When reactions are driven or forced, the elements or compounds will approach the most stable state. Normally, this state of stability produces a solid that is either less colloidal and less emulsified (or soluble) than the compound at equilibrium values. As this occurs, the contaminants form hydrophobic (i.e. having little or no affinity for water.) entities that precipitate and can easily be removed by a number of secondary separation techniques. Simply, electro-coagulation utilizes direct current to cause sacrificial electrode ions to remove undesirable contaminants (either by chemical reaction and precipitation or by causing colloidal materials to coalesce) and then to remove the contaminant materials by electrolytic flotation and/or through bottom removal. The electrochemical system has proven to be able to cope with a wide variety of wastewaters. These waters include paper pulp mill waste, metal plating, tanneries, canning factories, steel mill effluent, slaughter houses, chromate, lead and mercury laden effluents, as well as domestic sewage. These wastewaters can be reduced to clear, clean, odorless and reusable water. In some cases, such as domestic sewage, the treated water effluent can be better than the raw water from which it had originated.

As already stated, in the Electro-coagulation process, the electrical current is introduced into water via parallel plates constructed of various metals that are selected to optimize the removal process. Two of the more common plate materials are iron and aluminum. In accordance with Faraday's Law, metal ions will be split off or sacrificed into the liquid medium. These metal ions tend to form metal oxides that electromechanically attract to the contaminants that have been destabilized. The process of de-stabilizing suspended, emulsified or dissolved contaminants in an aqueous medium is by introducing an electrical current into the medium. Moreover, electro-coagulation generally takes place inside a substantially sealed treatment chamber, where the impurities are coagulated out of the aqueous medium. The electromotive force present in the reactor overcomes the Stem's forces disrupting the outer electron orbitals of dissolved ionic species and neutralizes colloidal particulate charges resulting in the destabilization of contaminants. This principal cathodic reaction is the reduction of hydrogen ion to hydrogen gas and the reduction of the valence state of some dissolved species. The anode sacrifices metallic ions into solution in accordance with Faraday's Law and liberates oxygen gas. The newly formed compounds may be precipitated as acid resistant metallic oxide complexes that may be agglomerated or flocculated and removed by conventional liquid-solids separation methodologies.

### C. Electro-Coagulation in General

The advantages over other waste treatment processes of Electro-coagulation (EC) systems and process in general are:

| | |
|---|---|
| A | Many wastewaters treated by EC yield palatable, clear, |
| | colorless and odorless water. |
| B | EC formed sludge tends to be readily settable and easy to |
| | de-water, because it produces hydrophobic complexes and |
| | low solubility metallic oxides and hydroxides. |
| C | EC formed flocs are similar to chemical flocs, except EC |
| | flocs tend to be much larger, contain less bound water, |
| | acid-resistant and more stable, and separate faster with |
| | filtration. |
| D | EC produces effluent with less total dissolved solids |
| | (TDS) content as compared with chemical treatments. If |
| | this water is reused, the low TDS level contributes to a |
| | lower water recovery cost. |
| E | The EC process has the advantage of removing the smallest |
| | colloidal particles, because the applied electric field |
| | sets them in faster motion, thereby facilitating the |
| | coagulation. |
| F | The EC process avoids the use of added chemicals so there |
| | is no problem neutralizing excess chemicals or the |
| | possibility of secondary pollution caused by chemical |
| | substances added at high concentrations when chemical |
| | coagulation is used treating wastewater. |
| G | The gas bubbles produced during electrolysis often carry |
| | pollutants to the top of the solution being treated where |
| | it can be more easily concentrated, collected and |
| | removed. |
| H | The electrolytic processes in the EC cell pack is |
| | controlled electrically and is easy to operate with |
| | sufficient operational latitude to handle wastewater |
| | conditions. |

### D. Prior Art

Other electro-coagulation systems have been disclosed and patented, each trying to convert contaminated water to purified water by separating the contaminants from the water. A diligent art search was conducted and revealed sixteen (16) US patents and two (2) patent application publications of significance. These documents as well as some of their prosecution history in the file wrapper were examined. The patents and publications searched and compared areas follows.

A device called a vertically disposed electrolytic cell used to produce hypochlorite solutions is shown in U.S. Pat. No. 3,849,281 issued to Bennett, et al in 1974. Disclosed is a substantially vertical bipolar electrolytic cell especially suited to the production of alkali metal hypo chlorites, divided into a plurality of cell units by horizontal partitions and featuring a bipolar electrode design. This device is particularly focused on producing materials for use as reagents in sewage treatment and not as a full industrial device or process for removing organics, particulates and dissolved metal contaminates from water. Next, a method of electrolysis which requires a pulsed current flow and sinuous fluid path is shown by U.S. Pat. No. 5,549,812 issued to Witt in 1996. Here, electrolysis of water is effected while the water flow is pulsed utilizing pulse direct current in an electrolyzer having a medium flow between pairs of electrodes and a meandering flow from electrode pair to electrode pair, thus treating waste water and producing a flocculate which is removed in a stilling or settling tank cascade. The current device and process incorporates the removal of particulates without a separate settling tank.

A particle separator is demonstrated in U.S. Pat. No. 5,759,390 issued to Essop in 1998. This invention relates to a separator device for the separation of fine particles from a contaminated liquid. The device utilizes the process of electrolysis to produce small gas bubbles. The separation is facilitated by the use of baffles and by inclined plates. No teaching of scrapers not the continuous removal of the particulate or post processing of the particulate materials and off-gases are taught. Then a process and apparatus for electro-coagulative treatment of industrial waste water is presented in U.S. Pat. No. 5,928,493 issued to Morkovsky in 1999. This is a process for the treatment of industrial waste water using electrocoagulation to effect separation of contaminants, which may include heavy metals, dyes, oils, fats, solvents, and salts. The process comprises passing waste water containing contaminants susceptible to electrocoagulation between pairs of electrodes within a reactor cell, energizing the electrodes with direct current, thereby breaking down and chemically altering contaminants in the electrolyzed water to form a sediment able flocculate therein. The process taught is very complex and occupies a rather large footprint as compared with the EcoFloc proposal.

Another apparatus for electro-coagulation of liquids is next shown in U.S. Pat. No. 6,139,710 that issued to Powell in 2000. This shows an electrocoagulation treatment device includes a plurality of spaced reaction plates disposed within a reaction chamber. A voltage is applied to selected reaction plates to create an electrical field within the electrocoagulation chamber. The plates are arranged vertically with respect to the chamber which induces a vertical flow of liquid through a device. Gases formed in the electrocoagulation process are allowed to rise to the top of the liquid line and can be vented to the atmosphere. The solids which precipitate out of the liquid stream are carried by the liquid stream to secondary separation. Any remaining solids can be removed as sludge through a drain in the bottom of the device. A foam cover is provided to isolate the electrical connections of the plates from moisture. The device is a basic, common electrocoagulation device without the sophisticated components shown by the Heffernan device and process. A process and apparatus for electro-coagulative treatment of industrial waste water is demonstrated in U.S. Pat. No. 6,294,061 issued to Morkovsky in 2001. It is an electrocoagulation system for removing contaminants from waste effluents comprising an electrocoagulation reactor having charged and uncharged plates and allowing serial flow of water there through. The process taught is very complex and occupies a rather large footprint as compared with the EcoFloc proposal.

Another method for electro-coagulation of liquids is provided in U.S. Pat. No. 6,488,835 issued to Powell in 2002. Here, an electrocoagulation treatment method wherein voltage is applied to selected reaction plates to create an electrical field within the electrocoagulation chamber. The plates are arranged vertically with respect to the chamber which induces a vertical flow of liquid through a device. Gases formed in the electrocoagulation process are allowed to rise to the top of the liquid line and can be vented to the atmosphere. The voltage and amperage of the electrical field within the reaction chamber may be adjusted as necessary by placing selected reaction plates in electrical contact with the voltage source. The incoming line voltage itself may be kept at a constant which eliminates the need for a separate transformer. The reaction plates are easily removed from the reaction chamber and may be replaced individually or as a set. The method is a basic, common electrocoagulation method without the sophisticated components shown by the Heffernan device and process. An electrocoagulation chamber and method is shown by U.S. Pat. No. 6,613,217 issued to Gilmore in 2003. Noted here is a stream of process liquid is treated while flowing through in a horizontally elongated chamber having an open top. Longitudinally elongated electrode blades are aligned with the longitudinal dimension of the chamber. An overhead disbursement chamber supplies a sweeping air stream over the open top of the chamber for removing foam and gas reaction by-products. The electrode blades are separated and held at a desired spacing by small portable guides located below and above the blades. The method or process is another rather basic, common electrocoagulation process without the sophisticated components shown by the EcoFloc device and process.

A process and apparatus for electro-coagulative treatment of industrial waste water in U.S. Pat. No. 6,689,271 issued to Morkovsky in 2004 shows another system. Here an electrocoagulation system for removing contaminants from waste effluents comprising an electrocoagulation reactor having charged and uncharged plates and allowing serial flow of water there through. The reactor is connected to a voltage source to charge some of the plates positive and some negative, with uncharged plates between the positive and negative plates. The system allows waste water to enter the reactor for coagulation therein, the waste water leaving the reactor to enter a defoam tank for agitation which allows trapped bubbles to rise to the surface of the tank as foam. From the de-foam tank, waste water goes through a sludge thickener, to allow sludge to settle at the bottom thereof and waste water is drawn off from the sludge thickener to flow to a clarifier. The pump removes sludge forming at the bottom of clarifier to take it back to the sludge thickener. The sludge is drawn out the bottom of the sludge thickener for transport to a press where most of the water is removed therefrom. Water is drawn off the top of the clarifier for transport to a conventional sewer system, or for reuse. The process taught is further expansion of a very complex and occupies a rather large footprint as compared with the Heffernan proposal. Next a process for electro-coagulating waste fluids is provided in U.S. Pat. No. 6,719,894 issued to Gavrel in 2004. Shown is an electrocoagulation process for removing organic and metal contaminants from a pressurized waste fluid is disclosed in which a clarified waste fluid is produced when the pressure is released. The process is an extensive, large combination of pipes, tanks, valves and pumps where one portion utilizes an electrocoagulation device. The entire treatment is under pressure, unlike the present invention.

A method and apparatus for electro-coagulation of liquids is shown in U.S. Pat. No. 7,211,185 that issued to Powell in 2007. It teaches an electrocoagulation treatment device includes a plurality of spaced reaction plates disposed within a reaction chamber. A voltage is applied to selected reaction plates to create an electrical field within the electrocoagulation chamber. The device includes various embodiments adapted for use as a large industrial batch unit or a portable unit or for use within the home. The device is another variation of a basic, common electrocoagulation device without the sophisticated components shown by the Heffernan device and process. Following this, an electro-coagulation waste water batch tank treatment system was provided by the U.S. Pat. No. 7,258,800 issued to Herbst in 2007. This taught and demonstrated a waste water treatment system and process for treating waste water received in a batch tank. The waste water is discharged in a headwork screen for removing large solids in the water. The solids are into a sludge drying bin. The screened water is transferred into a top of an influent surge tank with an oil/water separator. This is a batch process as compared to the continuous flow taught by the EcoFloc device and process.

Another electro-coagulation system received a U.S. Pat. No. 7,682,492 issued to Bradley in 2010. Here was taught an electrocoagulation device for removal of contaminants from a treatment stream including an elongated fluid treatment path in contact with a plurality of electrode plates, and a power supply electrically connected to the plates, wherein the device is configured so that it can provide a variety of electric field regimes to the treatment stream as it passes along the treatment path, and so that it can provide a variety of flow regimes along the fluid treatment path. This is a circular device without any scrapers to remove the reticent build-up of solids during the process. Another method and electrode construction for electro-coagulation treatment of water and waste water was awarded a U.S. Pat. No. 7,959,790 issued to Woytowich in 2011. Provided in this invention is an improved method for the electro-coagulation treatment of water and waste water includes an electrolytic cell having an anode and a helical cathode mounted longitudinally within a duct for receiving the contaminated water or waste water at one end and for discharging the treated water and electro-coagulated precipitates at the other end. The method teaches a single cell device to incorporate the method without incorporating or teaching the various ancillary portions to make the method suitable for industrial use.

A method for treating liquids with wave energy from an electrical arc received as U.S. Pat. No. 8,002,992 issued to Foret in 2011. Taught here is a method for treating a liquid is disclosed using an apparatus having: (a) a pump volute or hydrocyclone, (b) a throat connected to the pump volute or hydrocyclone head, (c) a parabolic reflector having a vertex, a focus and an opening at the vertex, wherein the opening is connected to the throat such that the vertex and focus are axially aligned with the central axis and the focus is not located within the throat, and (d) a wave energy source having a first electrode within the pump volute or hydrocyclone head that extends into the throat along the central axis of the throat, and a second electrode extending into the parabolic reflector proximate to the focus wherein the second electrode is spaced apart and axially aligned with first electrode. The liquid is supplied to the pump volute or hydrocyclone head and is irradiated by the wave energy source. The method requires a hydrocyclone or an equivalent—that being un-needed under the configuration and process taught with EcoFloc. Then a method and apparatus for electro-coagulation of liquids was shown by U.S. Pat. No. 8,048,279 issued to Powell in 2011. Taught is an electrocoagulation treatment device includes a plurality of spaced reaction plates disposed within a reaction chamber. A voltage is applied to selected reaction plates to create an electrical field within the electrocoagulation chamber. The plates are arranged vertically which induces a vertical flow of liquid through a device. The voltage and amperage of the electrical field chamber may be adjusted by placing selected reaction plates in electrical contact with the voltage source. One embodiment is adapted for treatment of fluid containing soluble or particulate organic compounds recalcitrant to biodegradation, including nitrogenous contaminants, such as ammonia or an ammonium compounds. The device and method of the invention include the use of an oxidizing agent such as sodium hypochlorite or hydrogen peroxide to aid in the removal of organic contaminants. The device is further variation of a basic, common electrocoagulation device without the sophisticated components shown by the Heffernan device and process.

A water and wastewater treatment system and process for contaminant removal is shown by Stephenson in Patent Publication 2002/0056688. Here is taught a system and process for removing contaminants from water and wastewater, where the water or wastewater is transformed into purified water that can be discharged to the environment. Wastewater is transported through several stations for purification, including an electrochemical cell. This system shows and teaches a full, highly complex waste treatment system and not a specific electro coagulation portion as with the EcoFloc invention. Finally, a method for Electrocoagulation of liquids is shown by Patent Publication 2010/0252447 submitted by Powell in 2010. This shows an electrocoagulation treatment device includes a plurality of spaced reaction plates disposed within a reaction chamber. A voltage is applied to selected reaction plates to create an electrical field within the electrocoagulation chamber. The plates are arranged vertically which induces a vertical flow of liquid through a device. The device includes various embodiments adapted for use as a large industrial unit, a portable unit or for use within the home. The voltage and amperage of the electrical field chamber may be adjusted by placing selected reaction plates in electrical contact with the voltage source. One embodiment is especially adapted for treatment of oil slop to remove water from the oil, and for treatment of seawater to desalinate the same. The device is further variation of a basic, common electrocoagulation method without the sophisticated components and methodologies shown by the Heffernan process.

Up until now, none of these systems have been able to solve the problems of variability, number and concentration of contaminants, and removal of the flocculants in the continuous treatment stream. These previous systems created large quantities of metal sludge and other contaminant sludge that sometimes actually added to the cost of disposal. Systems suffered from design problems such as not accounting for the production of generated gases or the build-up of impurities onto the working electrodes, or creating an electrolytic cell that is too complex and which cannot be easily maintained. Accordingly, there is a need for a wastewater treatment system and process that removes contaminants from the reaction chamber and provides for control of the off-gasses.

It appears that the Eco-Floc advanced electro-coagulation liquid waste treatment system and process provide novel, useful and non-obvious technological and economical merits when compared to prior art. It is not anticipated in other specifications, drawings or claims. None of the prior art reveals or appears to be a substantial equivalent (i.e. to perform substantially the same function, in substantially the same way, to achieve substantially the same result) as the Eco-Floc advanced electro-coagulation liquid waste treatment system and process. As far as is determined, there are no other special industrial electro-coagulation devices, systems or processes at the present time which fully provide these improvements and functional characteristics as the present Heffernan system presented here. It is believed that this device is made with fewer parts and with improved configurations and physical features to provide more functionality when compared to other currently utilized devices, systems or methods for electro-coagulation wastewater treatment.

### SUMMARY OF THE INVENTION

This Eco-Floc Advanced Electro-coagulation Liquid Waste treatment System is a special continuous cleaning electro-coagulation system. The advanced electro-coagulation system treats wastewater and the system utilizes a group of moving non-conductive scrapers located between a pair of electrodes so that the movement of the scrapers can clean each electrode during the treatment of the wastewater.

The system and technology allow for the energy efficient separation and removal of contaminants and impurities from a continuous stream of wastewater using electrolysis. The system treats the moving wastewater flows between pairs of electrode plates. The system is adaptable to a plethora of applications and liquids that require the removal of its contaminants and impurities. The various applications and some examples of use are shown and described below. One or more of the special electro-coagulation systems may be installed as new and original equipment option or an add-on system in various industries and situations that require removal of contaminants from a wastewater stream.

The preferred embodiment of the special Eco-Floc system to remove contaminants and impurities from a wastewater stream is comprised of various readily available components produced in in different configurations and made of various durable materials. More descriptions, illustrations and alternatives are discussed in the paragraphs below in the detailed description and operation sections. Simply stated, the special Eco-Floc system is:

“A continuous cleaning electro-coagulation system comprised of
1. A means 51 for conveying a liquid waste 50A into the Eco-Floc system 30;
2. A means 56 for collecting and conveying pre-treatment heavies 59B;
3. An electro-coagulation treatment zone 55A, consisting of at least one pair of electrodes 40 with opposingly faced reactive surfaces, through which, said liquid waste 50A will pass between;
4. A means 64 for scraping the electrodes 40 on a continuous or intermittent basis, to keep the reactive surfaces of the electrodes 40 clean;
5. A means 70 for conveying by which the treated liquid waste 69 exits the treatment zone 55A;
6. A means 70B for collecting and conveying any floating solids in the exit zone 69A of treated liquid waste 69;
7. A means 80 for collecting and conveying any post treatment heavy solids 59C in the exit zone 69A of treated liquid waste 69;
8. A receiving vessel 76A into which the essentially clear treated liquid waste 49 [without heavy or floating solids] flows;
9. A source 60 of electrical power, which may provide an appropriately configured, as alternating or direct, electrical current;
10. A means 63A for connecting the source 60 of electrical power and the paired electrodes 40, which may number from two to hundreds;
11. A means for transferring and controlling 63 the amount of electrical power delivered to the electrodes 40;
12. A means 91 for collecting and drawing the off-gasses produced in the treatment zone 55A from a headspace above the electrodes 40 of the Eco-Floc system 30;
13. A means 95 for storing the off-gasses of the system 30, said gasses consisting primarily of brown gas 90;
   whereby the electro-coagulation system treats wastewater and the system utilizes a group of moving non-conductive scrapers located between a pair of electrodes so that the movement of the scrapers can clean each electrode during the treatment of the wastewater.”

### OBJECTS AND ADVANTAGES

There are several objects and advantages of the special Eco-Floc electro-coagulation system. The technology allows for the energy efficient separation and removal of contaminants and impurities from continuous wastewater streams.

With the Eco-Floc system, the application of a direct electric current to waste produces multiple simultaneous electro-chemical reactions that serve to:
Coagulate solids into insoluble flocs facilitating more thorough separation and improved dewatering;
Dramatic reductions in BOD, COD;
Breaking of colloids and emulsions;
Destruction of bacteria and viruses through cell lysing; and,
Moves acidic or alkaline wastes toward neutrality.

This manner of processing with the Eco-Floc system results in several benefits. These include: 1. Using No Polymers or Chemicals; 2. Meeting Discharge Requirements for streams and rivers and the like; 3. Reducing Sludge Volume; 4. Having the capability to Process Multiple Contaminants; and 5. Having the capability to Process Waste Streams with up to 6% solids.

The unique advantages of the special Eco-Floc electro-coagulation system are shown in the following table.

| No. | Advantage - The Eco-Floc system has: |
|---|---|
| 1 | A heavy duty, robust industrial mechanical design; |
| 2 | Designs which include many improvements over |
| | traditional designs through state of the art telemetry |
| | and control loops that effectively adjust the device to |
| | optimize the process; |
| 3 | A new design concept that powers each cathode and anode |
| | thereby increasing the overall reaction chamber |
| | efficiency of the design many times over the |
| | traditional powered and static plate design; |
| 4 | A power transmission delivery that utilizes PWM (Pulse |
| | Width Modulation) of 4 KHz primary with an amp |
| | monitoring S-Curve secondary delivery; |
| 5 | An optional utilization of a nominal 24VDC systems |
| | which aids in lowering the total incoming power |
| | required while giving the system the much need treating |
| | power for even the most difficult applications; |
| 6 | A continuous cleaning mechanism that not only removes |
| | the solids that adhere to the reaction plates, but also |
| | clears sludge “caking” and inert blockages a well; |
| 7 | A way to capture the gases given off by the process |
| | giving the end user the ability to use the Brown's gas |
| | for other applications; |
| 8 | An integration of the settling tanks with an agitator |
| | feed to the system to ensure a consistent treatment and |
| | adequate dwell time before dewatering the solids; and |
| 9 | An optional water misting system recycled from the |
| | processed side to help reduce foaming reaction and aid |
| | in cooling the electrodes. |
| 10 | Easily removed and replaced anode plates that permit |
| | efficient and simple use of sacrificial anodes if |
| | desired. |

Finally, other advantages and additional features of the present special Eco-Floc Electro-coagulation system to remove contaminants and impurities from a continuous wastewater stream will be more apparent from the accompanying drawings and from the full description of the device. For one skilled in the art of electro-coagulation devices, systems and processes, it is readily understood that the features, configurations and materials shown in the examples with this novel Eco-Floc Electro-coagulation are readily adapted to other types of electro-coagulation systems and devices.

### DESCRIPTION OF THE DRAWINGS

### Figures

The accompanying drawings, which are incorporated in and constitute a part of this specification, illustrate an embodiment of the advanced, self-cleaning Electro-coagulation Liquid Waste Treatment System, the system is known as Eco-Floc. The drawings together with the summary description given above and a detailed description given below serve to explain the principles of the special electro-coagulation system to treat wastes and wastewater materials. It is understood, however, that the special system to treat waste and wastewater is not limited to only the precise arrangements and instrumentalities shown.

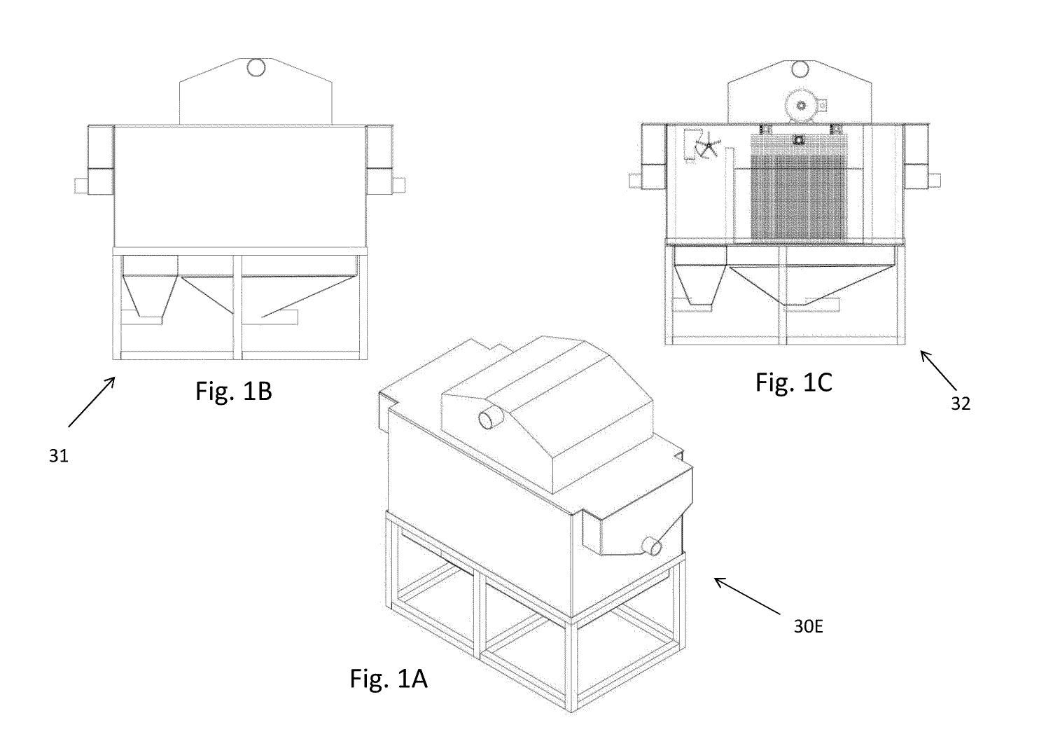

FIGS. 1 A through 1 C are sketches of the general Eco Floc electro-coagulation system.

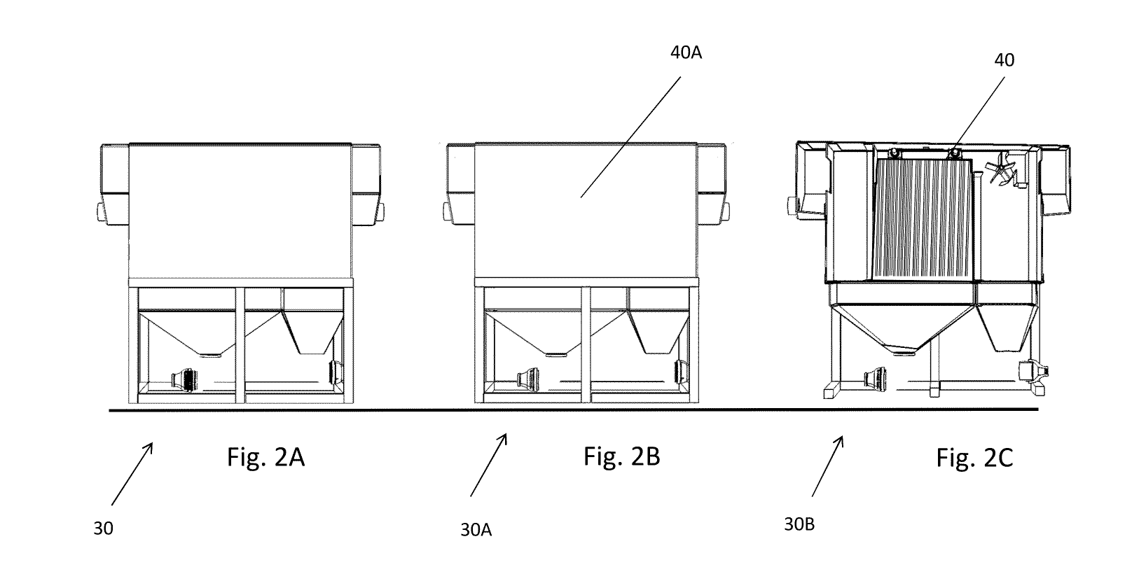

FIGS. 2 A through 2 C are sketches of the general Eco Floc electro coagulation system from a side view in progressive frames with components and featured notes.

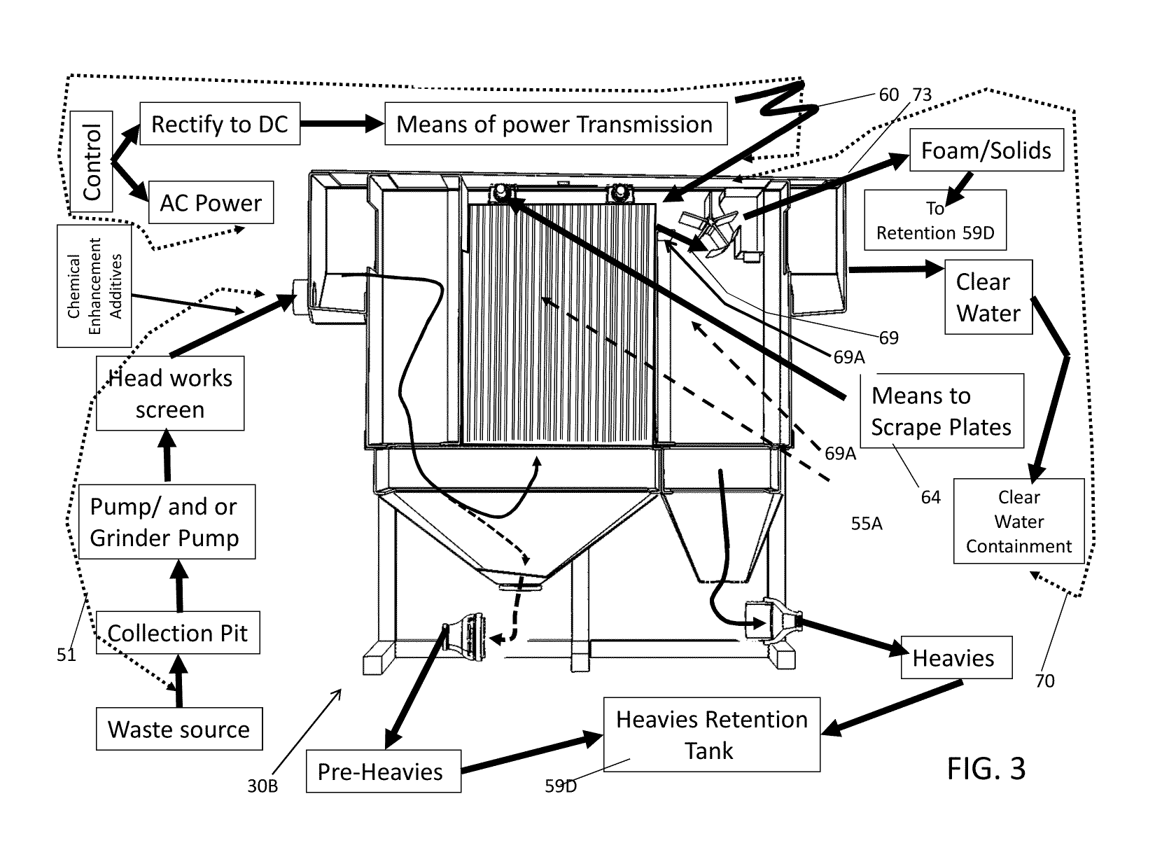

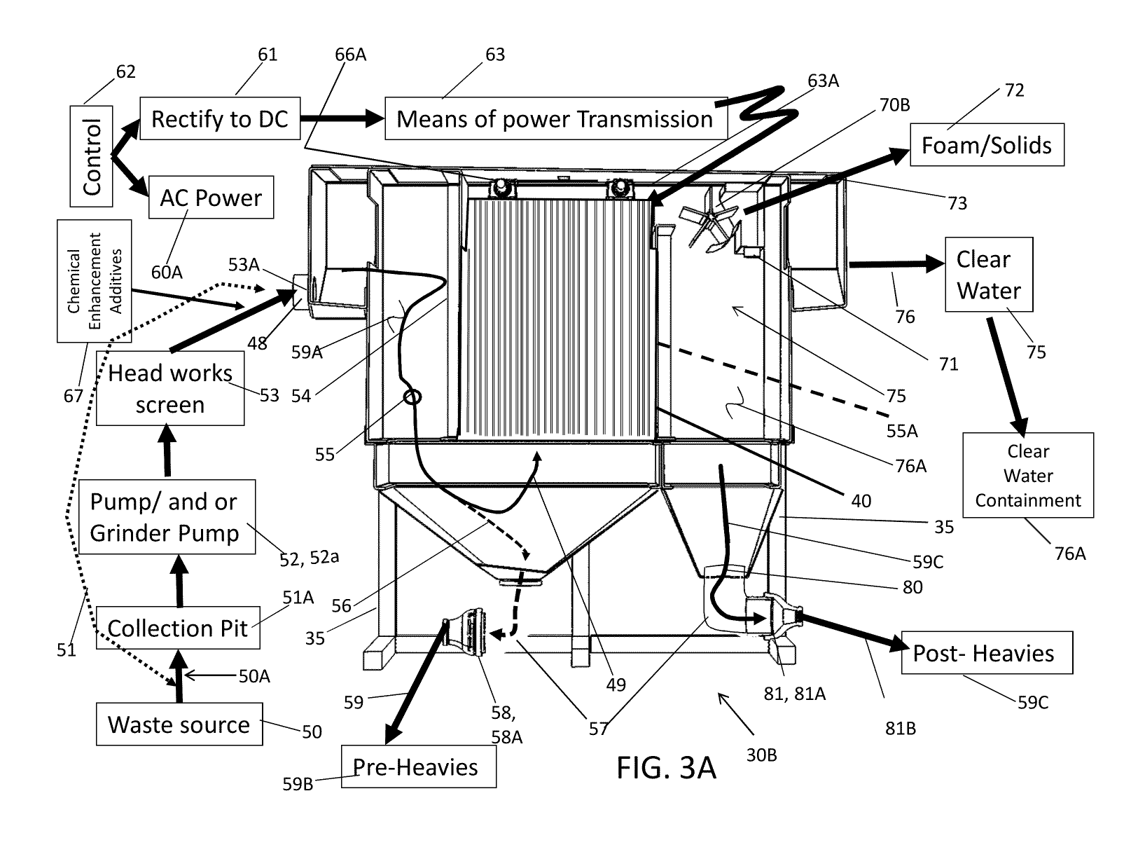

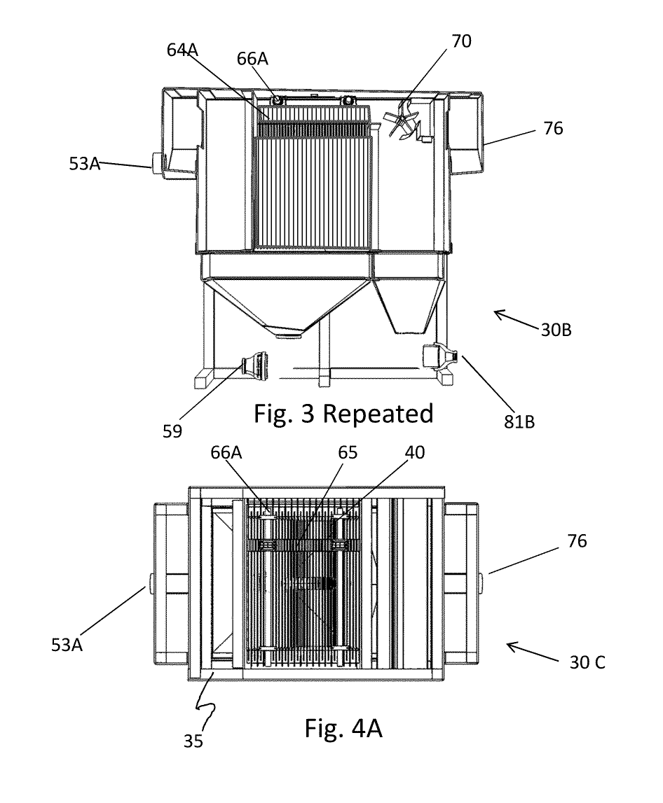

FIG. 3 is a sketch of the Eco Floc coagulation system from a side section with input and output features shown. FIG. 3 A is a sketch of the Eco Floc coagulation system from a side section with the components and input and output features shown.

FIG. 4 A and the FIG. 3 repeated are sketches of an Eco Floc coagulation system with the components and features shown together from generally a side and top view.

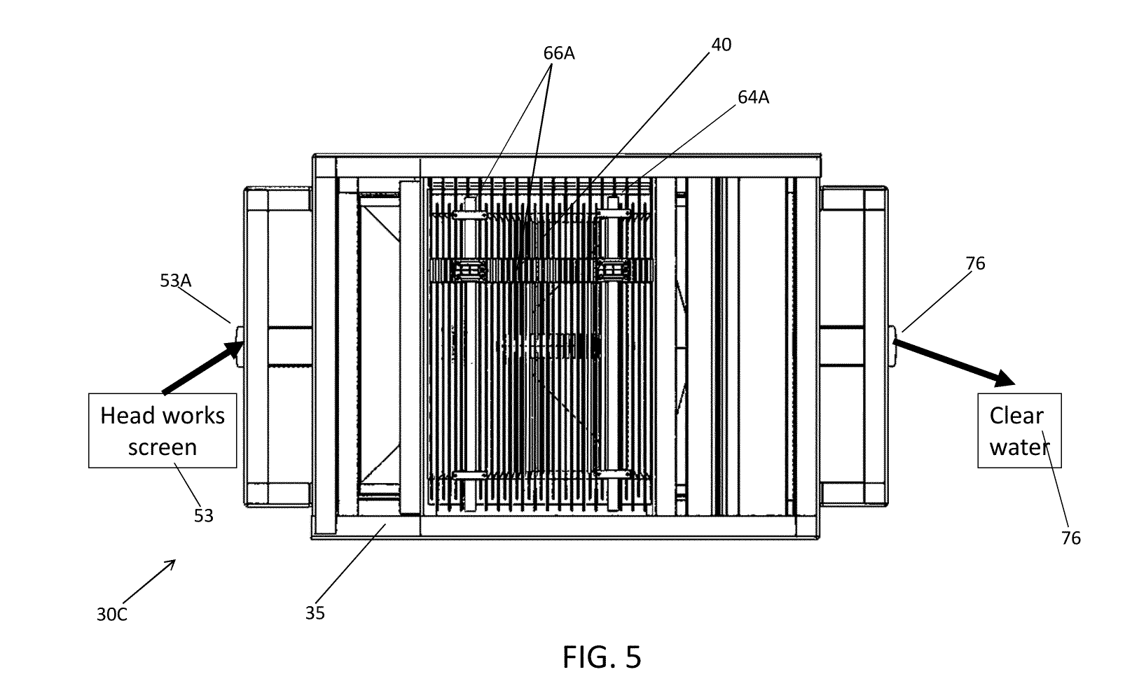

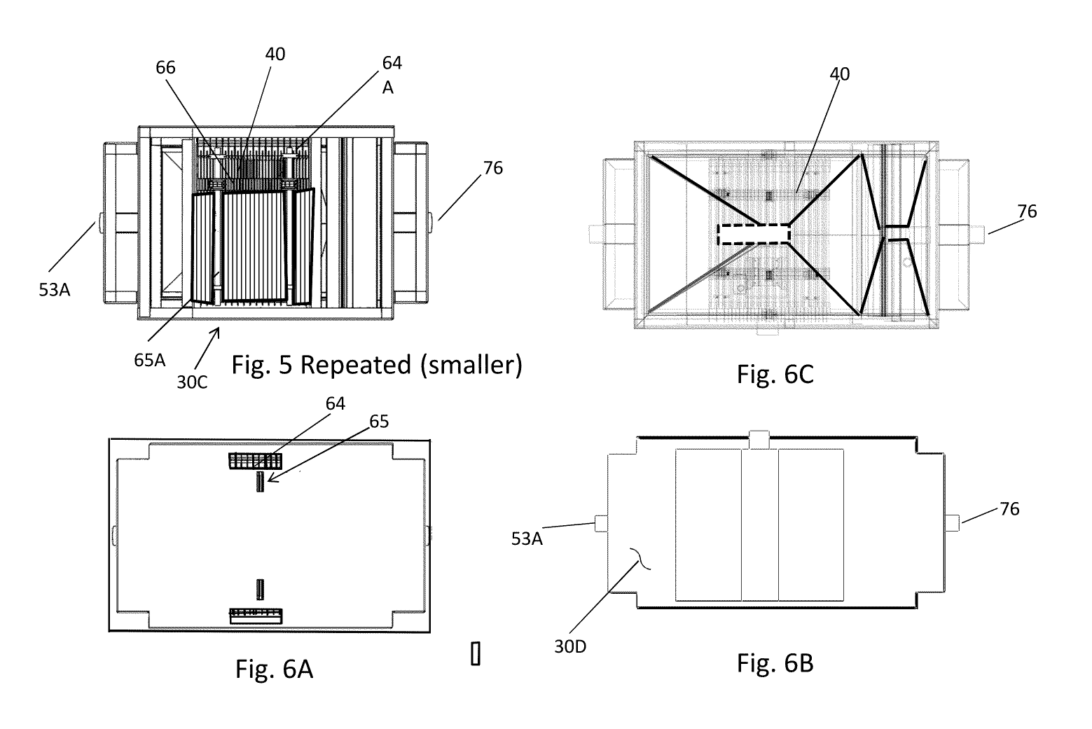

FIG. 5 is a sketch of the Eco Floc coagulation system from a top view with components and features shown.

FIG. 6 A through 6 C are the Eco Floc coagulation system with consecutive top views and features shown.

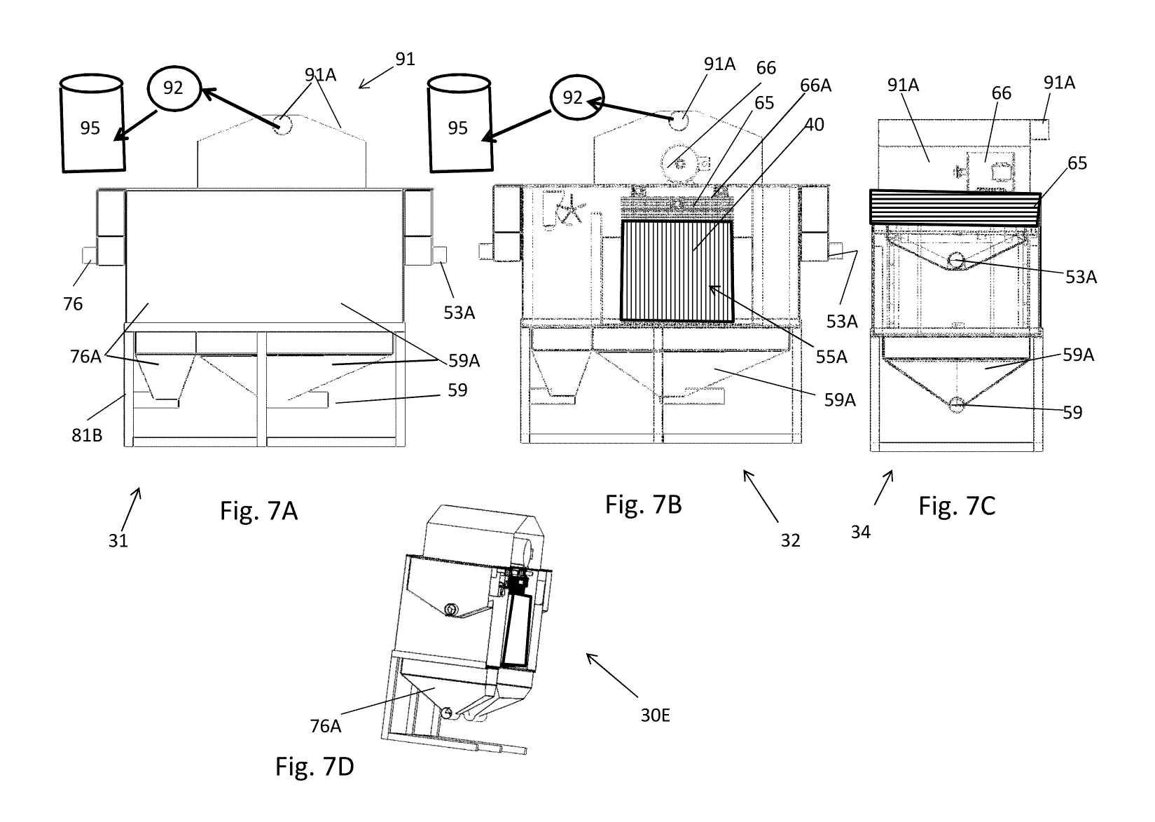

FIG. 7 A through 7 D are sketches of the Eco Floc coagulation system from side, end and isometric views with components and features shown.

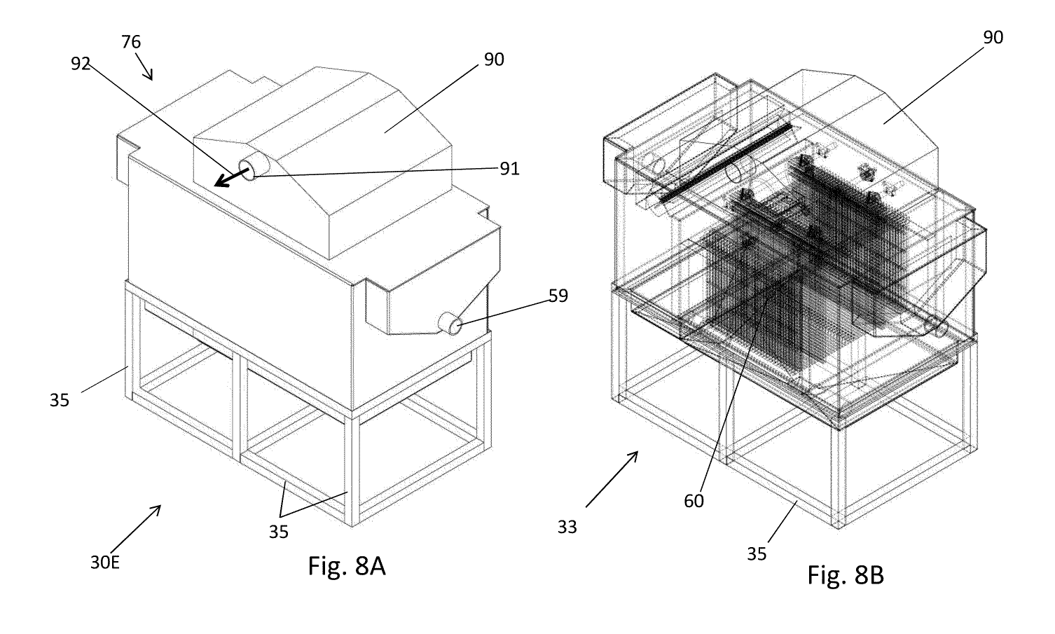

FIGS. 8 A and 8 B are sketches of the Eco Floc coagulation system from isometric views with components shown.

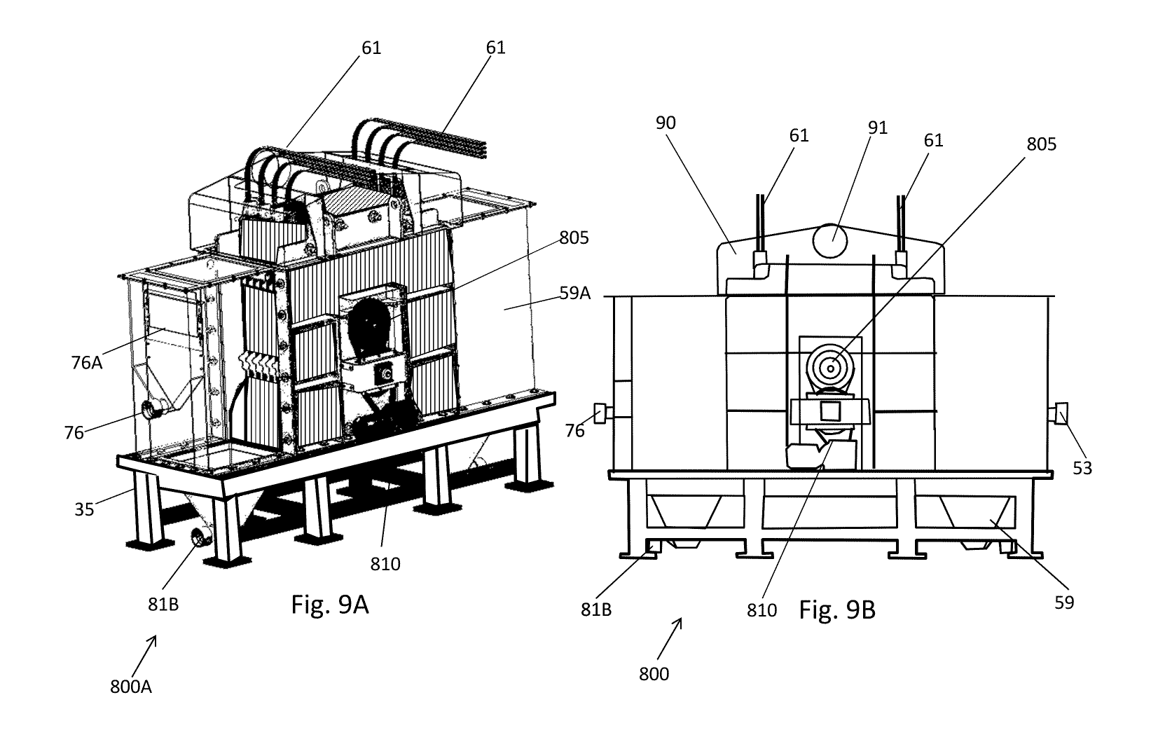

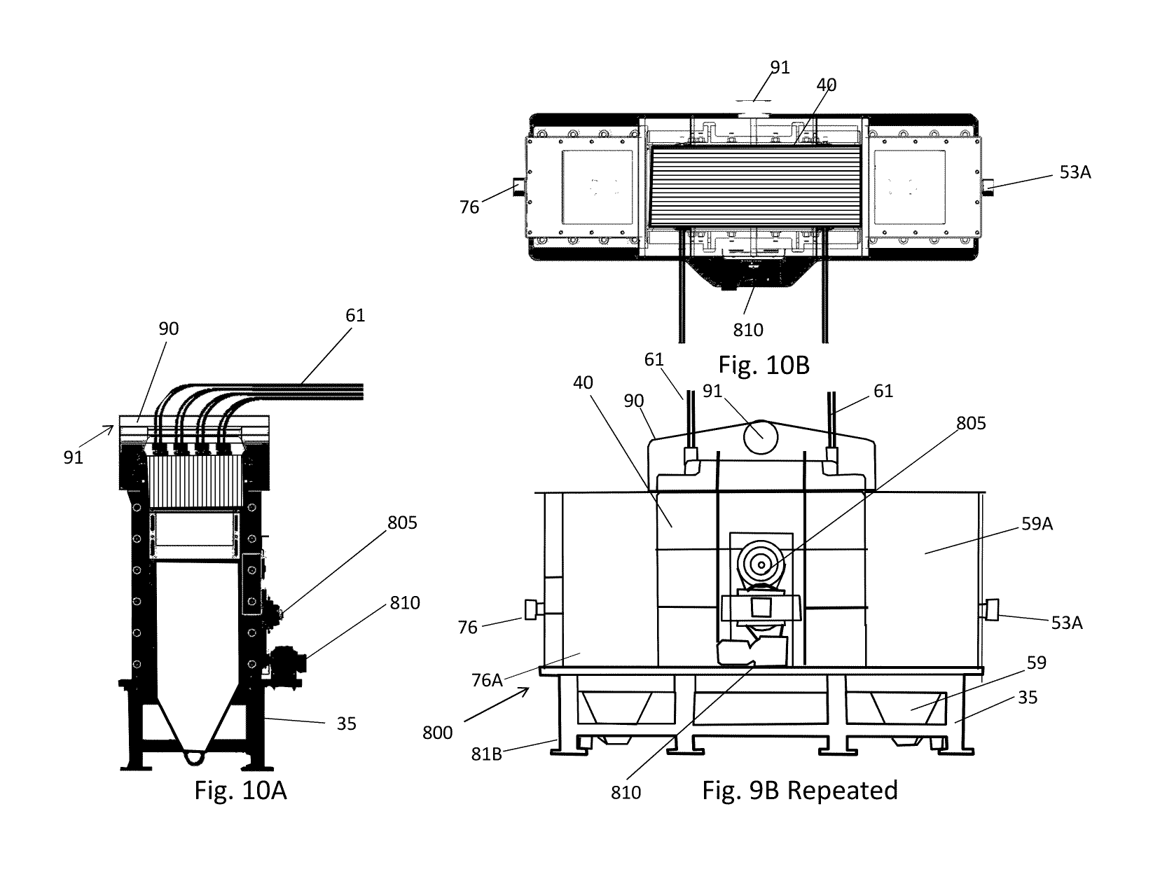

FIGS. 9 A and 9 B are views of an alternative embodiment of a Eco Floc system with rotating disk scrapers between the coagulation plates.

FIG. 10 A through 10B are front, side and top views of the alternative embodiment.

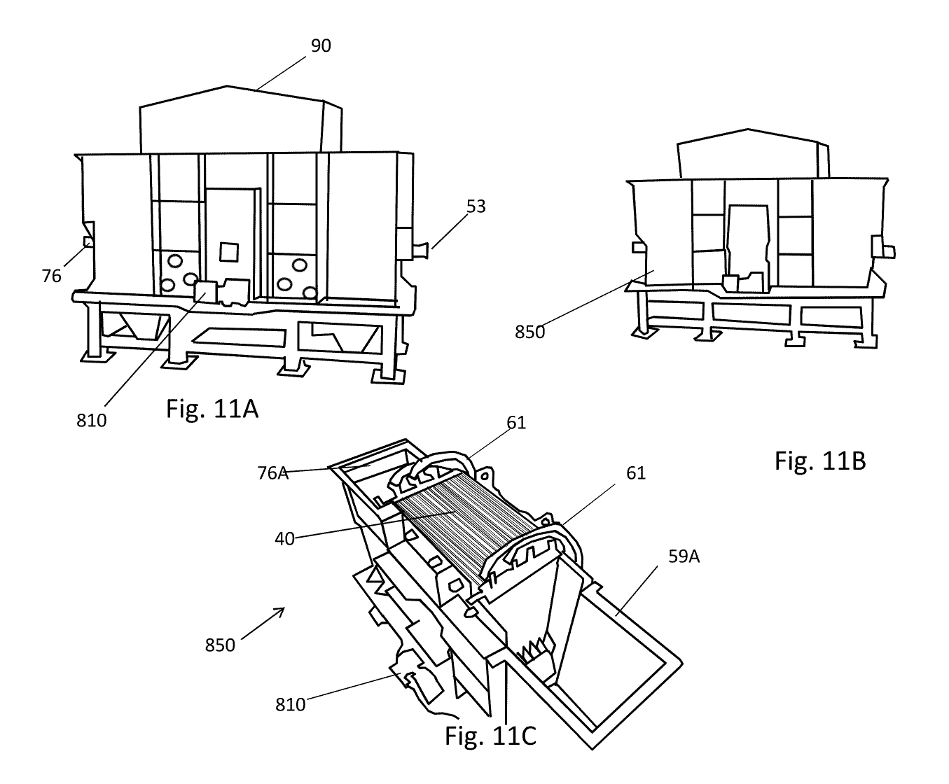

FIG. 11 A through 11C are pictures of the alternative rotating disc Eco Floc system.

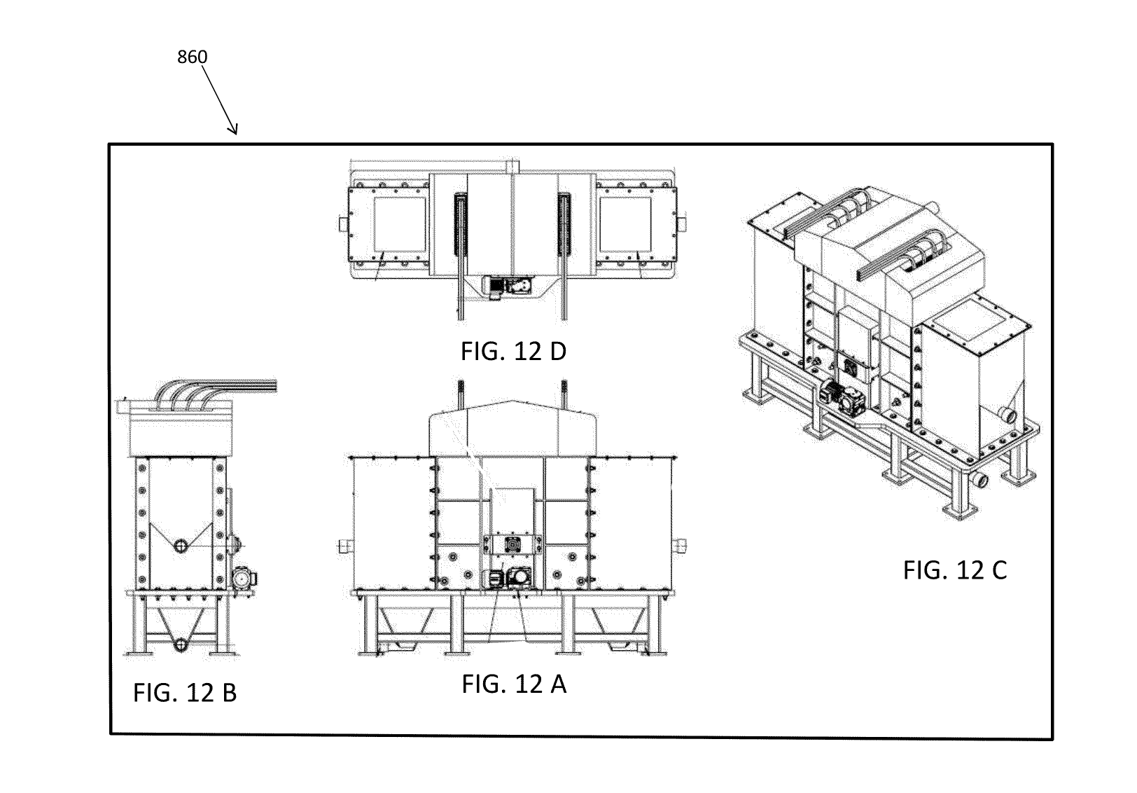

FIG. 12 A through 12 D are sketches of the alternative rotating disc Eco Floc coagulation system.

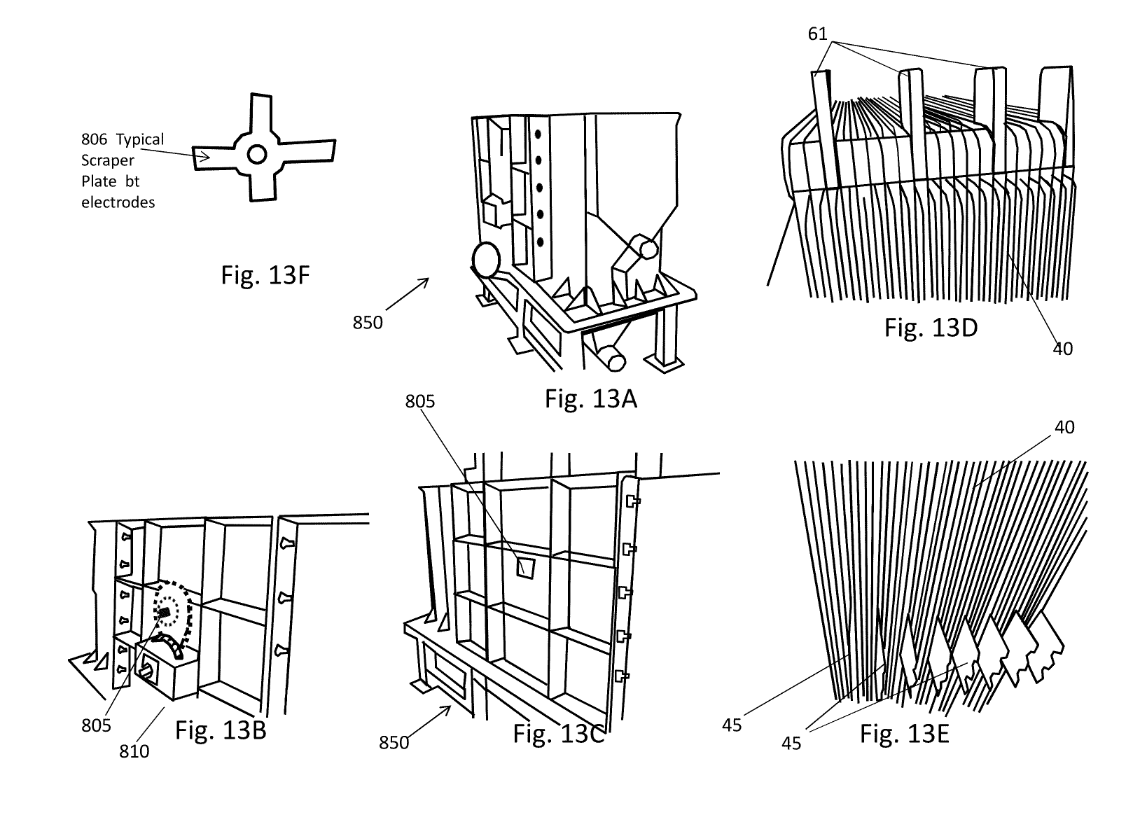

FIG. 13 A through 13 F are pictures of a prototype of the alternative Eco Floc Electro Coagulation system with components and features shown.

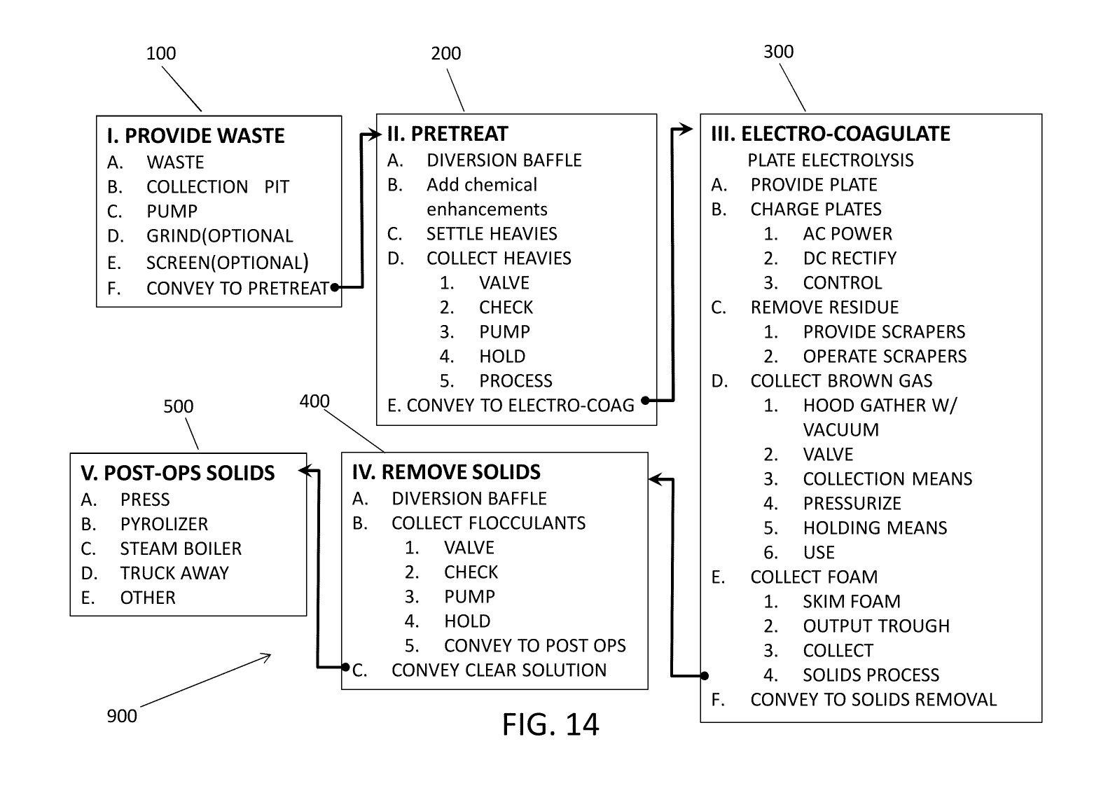

FIG. 14 is a chart of the Eco Floc Electro Coagulation method.

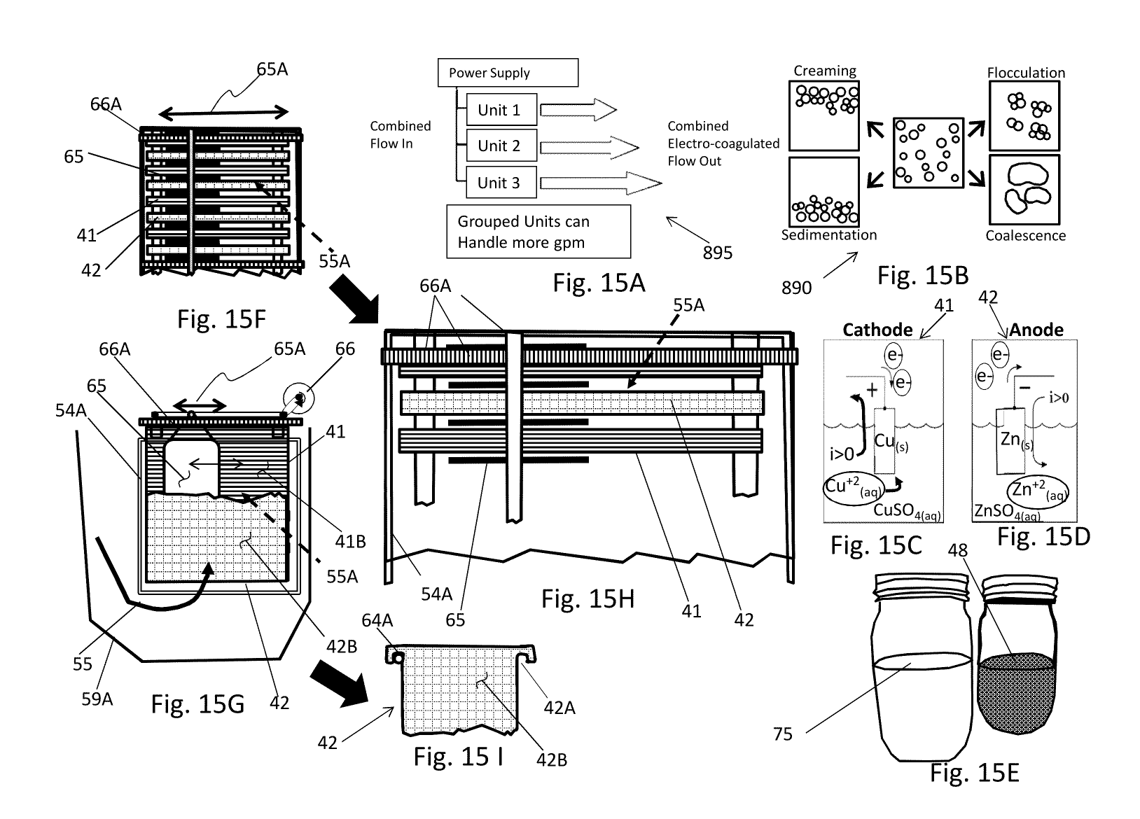

FIGS. 15 A through 15 I are sketches of various components and explanatory slides for the Eco Floc Electro Coagulation system.

### DESCRIPTION OF THE DRAWINGS

### Reference Numerals

The following list refers to the drawings:

| Ref # | Description |
|---|---|
| 30 | General Eco Floc Electro-Coagulation System(EFCS) |
| 30A | General EFCS with shadow of plate system |
| 30B | Front section view of EFCS |
| 30C | Top section EFCS |
| 30D | Top Surface |
| 30E | Isometric |
| 31 | Back side view of EFCS |
| 32 | Back section view of EFCS |
| 33 | Isometric without the exterior plate of EFCS |
| 34 | Back side section view of the EFCS |
| 35 | EFCS Structural support |
| 40 | Electrolysis dual pair of electrodes (Anode and cathode) Plate |
| | System |
| 40A | Shadow of Electrolysis Plate System |
| 41 | Cathode |
| 41B | Surface of the electrode cathodes |
| 42 | Anode |
| 42A | Anode support slot (permits ease of replacement) |
| 42B | Surface of the electrode anodes |
| 45 | Separator/Cleaner |
| 48 | Liquid with impurities |
| 49 | Liquid without pre-treatment heavy solids, ready for EC treatment |
| 50 | Waste Source (Agriculture, Industrial, Sewer, etc) |
| 50A | Liquid waste |
| 51 | A means for conveying a liquid waste into the Eco-Floc system |
| 51A | Collection Pit |
| 52 | Pump |
| 52A | Grinder Pump |
| 53 | Head works screen |
| 53A | Head works influent point |
| 54 | Baffle/Diverter Plate |
| 54A | Support frame for electro-coagulation |
| 55 | Flow of waste stream to the Electro-Coagulation zone 55A |
| 55A | An electro-coagulation treatment zone, consisting of at least one |
| | pair of electrodes with opposingly faced reactive surfaces, through |
| | which, said liquid waste will pass between |
| 56 | Heavy Solids Drop - A means for collecting and conveying |
| | conveying pre-treatment heavies 59B |
| 57 | View Pipe |
| 58 | Valve System |
| 58A | Valve and Check |
| 59 | Heavy solids Exit Out |
| 59A | Heavy solids Container Tank - Electrolytic reaction tank |
| 59B | Pre-Heavy solids - inerts, large masses, drops from solution prior |
| | to electro-coagulation |
| 59C | Post-Heavy solids - inerts, masses, drops from solution after |
| | electro-coagulation |
| 59D | Heavies Retention Tank |
| 60 | A source of electrical power, which may provide an appropriately |
| | configured, as alternating or direct, electrical current |
| 60A | AC Power |
| 61 | Rectifier to DC Power |
| 62 | Control of AC to DC Power - |
| 63 | Means to transfer and control power to Electrode Plates - A means |
| | for controlling the amount of electrical power delivered to the |
| | electrodes (alternative control anticipates a high frequency pulse) |
| 63A | A means for connecting the source of electrical power and the |
| | paired electrodes, which may number from two to hundreds |
| 64 | A means for scraping the electrodes on a continuous or intermittent |
| | basis, to keep the reactive surface of the electrodes clean; |
| 64A | Electrode Supports |
| 65 | Plate Scrapers |
| 65A | Plate Scraper movement |
| 66 | Plate Scraper movement means (motor) |
| 66A | Plate Scraper Support System |
| 67 | Chemical Enhancements |
| 69 | Post-Electro-coagulated liquid - treated liquid |
| 69A | Exit zone or Post Electro-Coagulation Treatment zone |
| 70 | A means for conveying by which the treated liquid waste 69 exits |
| | the treatment zone 55A |
| 70A | A means for collecting and conveying any floating solids in the |
| | exit zone of treated liquid waste; [70B, 71, and 72] |
| 70B | Foam Wheel |
| 71 | Foam Trough |
| 72 | Foam Collection to Solids retention |
| 73 | Foam or floating solids and flocs |
| 75 | Clean Water |
| 76 | Clean Water Exit/Collection point |
| 76A | Clear Containment Tank A receiving vessel into which the treated |
| | liquid waste [without heavy or floating solids] flows |
| 80 | A means for collecting and conveying any heavy solids in the exit |
| | zone of treated liquid waste |
| 80A | Heavy Exit |
| 81 | Heavy solids Valve |
| 81A | Heavy solids check valve |
| 81B | Heavy solids exit |
| 90 | Brown Gas aka bio gas |
| 91 | A means for collecting and drawing the off-gasses produced in the |
| | treatment zone from a headspace above the electrodes of the Eco- |
| | Floc system; (hood 91A and vacuum 92) |
| 91A | Brown Gas Exit Hood - under vacuum 92 |
| 92 | Vacuum pull on brown gas |
| 95 | Holding Means - A means for storing the off-gasses of the system, |
| | said gasses consisting primarily of brown or bio gas |
| 100 | Provide Waste |
| 200 | Pretreat |
| 300 | Electro Coagulate |
| 400 | Remove Solids |
| 500 | Post Operate on Solids |
| 800 | Alternate EFCS Rotating Plate |
| 800A | Isometric of Alternative EFCS |
| 805 | Rotating Plate Axis |
| 806 | Typical Rotating Scraper piece between each set of electrodes |
| | Plate Axis |
| 810 | Rotating Plate (means to rotate) |
| 850 | Alternate EFCS Prototype |
| 860 | Alternate EFCS Drawings of Prototype |
| 890 | Physical molecule convergence |
| 895 | Multi electro-coagulation machine arrangement |
| 900 | Process diagram for Eco-Floc electro-coagulation |

### DETAILED DESCRIPTION OF PREFERRED EMBODIMENT

The present new system embodied here is a special Eco-Floc electro-coagulation system. It is a continuous cleaning electro-coagulation system. It utilizes moving non-conductive scrapers located between electrodes so that the movement of the scrapers can clean each electrode. More particularity, the invention utilizes an electro-coagulation process to convert the impurities and dissolved metal contaminates to suspended particles where upon the dissolved gases help the suspended particles rise to the waste fluid surface to facilitate the contaminants to be removed or separated. The system and process are used for the treatment of various types of liquid streams by electrolysis for the removal of undesirable substances from a treatment stream. Particularly they are for cleaning the waste water by utilizing an electro-coagulation process to change the particle from in solution to a particle in suspension which can be flocculated and separated from the water.

The Eco-Floc electro-coagulation system also has full electrical controls to “tune in” the removal of specific impurities. The sacrificial anodes (electrode plates) are easily removed and replaced. The applications of the Eco-Floc system and associated process anticipate many applications and adapts well both to existing operations as well as entirely new installations.

The advanced, self-cleaning Electro-coagulation Liquid Waste Processing System is sometimes known as Eco-Floc. The advantages for the special Eco-Floc electro-coagulation system 30—to remove contaminants and solids from solutions of various water and wastewater allows for enhanced treatment and clarification of the solutions—are listed within this application. There are both advantages for electro-coagulation in general as well as benefits, capabilities and specific advantages to the Eco-Floc electro-coagulation system 30 due to its unique features and configurations.

The preferred embodiment of the special electro-coagulation treatment system and process known as Eco-Floc is comprised of various readily available components produced in in different configurations and made of various durable materials. Simply stated, the special system is:

Eco-Floc Advanced Electro-coagulation Liquid Waste treatment System is a continuous cleaning electro-coagulation system developed by Enviro Solve Technologies. It utilizes moving non-conductive scrapers located between electrodes so that the movement of the scrapers can clean each electrode.
Simply stated, the special Eco-Floc system is:
“A continuous cleaning electro-coagulation system comprised of
1. A means 51 for conveying a liquid waste 50A into the Eco-Floc system 30;
2. A means 56 for collecting and conveying conveying pre-treatment heavies 59B;
3. An electro-coagulation treatment zone 55A, consisting of at least one pair of electrodes 40 with opposingly faced reactive surfaces, through which, said liquid waste 50A will pass between;
4. A means 64 for scraping the electrodes 40 on a continuous or intermittent basis, to keep the reactive surfaces of the electrodes 40 clean;
5. A means 70 for conveying by which the treated liquid waste 69 exits the treatment zone 55A;
6. A means 70B for collecting and conveying any floating solids in the exit zone 69A of treated liquid waste 69;
7. A means 80 for collecting and conveying any post treatment heavy solids 59C in the exit zone 69A of treated liquid waste 69;
8. A receiving vessel 76A into which the essentially clear treated liquid waste 49 [without heavy or floating solids] flows;
9. A source 60 of electrical power, which may provide an appropriately configured, as alternating or direct, electrical current;
10. A means 63A for connecting the source 60 of electrical power and the paired electrodes 40, which may number from two to hundreds;
11. A means for transferring and controlling 63 the amount of electrical power delivered to the electrodes 40;
12. A means 91 for collecting and drawing the off-gasses produced in the treatment zone 55A from a headspace above the electrodes 40 of the Eco-Floc system 30;
13. A means 95 for storing the off-gasses of the system 30, said gasses consisting primarily of brown gas 90;
   whereby the electro-coagulation system treats wastewater and the system utilizes a group of moving non-conductive scrapers located between a pair of electrodes so that the movement of the scrapers can clean each electrode during the treatment of the wastewater.”

There are shown in FIGS. 1-15 complete descriptions and operative embodiments of the special continuous and self-cleaning electro-coagulation system and process to treat and remove contaminants and solids from water and wastewater solutions. In the drawings and illustrations, one notes well that the FIGS. 1-15 demonstrate the general configuration of this system. The various example uses are shown in FIGS. 3, 13, 14 and 15 along with this written specification.

The accompanying drawings, which are incorporated in and constitute a part of this specification, illustrate a preferred embodiment of the special continuous and self-cleaning electro-coagulation system and process. The drawings together with the summary description given above and a detailed description given below serve to explain the principles of the special system known as the advanced, self-cleaning Electro-coagulation Liquid Waste System and Process known as Eco-Floc. It is understood, however, that the Special solids and contaminant removal system is not limited to only the precise arrangements and instrumentalities shown. Other examples of systems that may remove contaminants and solids materials are still understood by one skilled in the art of electro-coagulation systems and processes to be anticipated within the scope and spirit of both the system and process shown here.

FIGS. 1 A through 1 C are sketches of the general Eco Floc electro-coagulation system 30. Here is a general back view 31, a section view 32 through the front and an isometric sketch 33 of the system 30. Components and features are described below.

FIGS. 2 A through 2 C are sketches of the general Eco Floc electro coagulation system 30 from a side view. Next, progressive frames with components and features are noted. Shadowed in the FIG. 2 B side view 30A is the shadow view 40A of the plate system interior to the Eco-Floc electro-coagulation system 30. In FIG. 2 C the section front view 30B shows the electrolysis dual pairs 40 (sacrificial anodes 42 and cathodes 41) all interior to the system 30.

FIGS. 3 and 3A are sketches of the Eco Floc coagulation system 30 from a side section with input and output features shown. FIG. 3 is an overview and FIG. 3 A shows more of the component and feature details. These views show the means 51 for conveying the liquid waste 50A into the Eco-Floc system 30. This is accomplished by having a waste source 50 such as a dairy or other application (as described in Operations, below). The liquid waste 50A is transferred or collected in some manner such as a collection pit 51A. Next it is conveyed or transferred by pumps 52 or optional grinder pump or shredder 52A or an equal means. Often a head works screen 53 with perforations and a self-cleaning scraper or flushing means is employed to filter and remove large inerts and masses that may interrupt or slow the flow of the liquid waste 50A. This may be a simple device or more complex one with scraping and surface cleaning features. These headwork screens are typical and readily available in the waste treatment industry. However, combining them 53 with an electro-coagulation machine or system 30 was not shown in prior art and is believed to be a novel combination. After the pumps 52, 52A and screen 53, the waste 50A reaches the influent point 53A of the system 30. In or around this influent point 53A is where chemical enhancements 67 and adjuncts may be added. These may vary from compounds to enhance the electrolysis process—such as ferrous-chlorides, ferrous-sulfides and other ferrous or iron compounds to enhance the anode actions by adding source metals . . . or to flocculant enhancers and adjuncts for aiding a faster solidification and coalescence. Although electro-coagulation does not need the chemicals 67 per say, the additives 67 may be desired for improving the collection of some impurities and suspended solids.

As the waste water 53 enters the main system 30 at the influent point 53A, it now becomes generally a liquid 48 with impurities and suspended solids since some filtering or grinding of the larger masses and inerts have been screened (by screen 53A or ground-up by grinder 52A. The liquid material 48 is being pumped (by pump 52, 52A) and has some force. It then strikes a baffle plate 54 and continues as a flow 55 through the heavy solids retainer tank 59A and into the electro-coagulation zone 55A where the electrodes 40 are located. Since being diverted, some additional pre-heavy solids 59B drop and provide a means for collecting heavies 56 prior to treatment in the electro-coagulation zone 55A. These pre-heavies 59B continue through a site glass or view pipe 57 and through a valve 58 and optional check valve 58A to the heavies exit point 59. The remaining liquid 49 is free of some of these impurities.

Returning to the flow of liquids 49 with impurities into the treatment zone 55A within the electrode plates 40, one notes that the liquid is forced up and around the plates 40 giving the liquid 49 ample exposure—both as time and as contiguous flow across the boundary layer of the electrode plates 40—to both the cathode 41 and anode 42 plate surfaces. Here the electrolysis occurs. One may also note the electrode plates 40 are within a chamber or zone 55A formed from the heavy solids container 59A (tank). The tank 59A is all part of the Eco-Floc electro-coagulation system 30 which has an interconnected structural support 35 made from common structural members (square or round tubes, angles, I, H or C sectioned members and the like). At the exit point 69A the post-treated liquid 69 exits the treatment zone 55A.

Upon exiting at the end or exit of treatment 69A the post-treatment 69 is a combination of foam 73 and clear water 76. This combined liquid 69 is conveyed by a means 70 of conveying post treatment liquid 69. This means includes a means 70A for conveying and collecting any floating solids (foam 73) in the post-treatment liquid 69. One such exemplary and not limiting means 70A is with a foam wheel 70B, a trough 71 and a foam collection tank 72 and then on to a common solid retention tank 59D. Once the foam 73 is removed, the clear water 75 is left inside the clear water containment tank 76A—once again also secured (like the heavy tank 59A) to the framework structure 35 of the Eco-Floc electro-coagulation system 30. The clear and essentially clean water 75 then exits the Eco-Floc electro-coagulation system 30 at the exit point 76 and is conveyed to the clear water containment structure 76A for use or disposal.

Further review of FIGS. 3 and 3 A provide insight into the system's 30 means 64 for scraping the electrodes 40 on a continuous or intermittent basis to keep the reactive surface of the electrodes clean and clear for electrolysis. The means 64 includes non-conductive scrapers 65, the scraper support system 66A, and a movement means 66 (for example such as a motor and gear, belt, chain, eccentric linkage or equal) or another drive system. This scraper 65 is between the electrode pairs 40 and serves to both clean and free coagulating floc masses by the movement 65A of the scraper 65 as well as scrape and clear the actual surface of the electrodes 40(anodes 42B and cathodes 41B). The scraper 65 therefore clears the path and chamber 55A of any appreciable solids loading.

The electrodes 40 may be resilient and of various materials. The anodes may be common sacrificial types or long life, mixed metal oxide coated (iridium) for higher current densities and higher efficiencies. These may be non-degrading with longer life. The trade-off of cost versus efficiency must, of course, be considered. It is anticipated that the electrodes are paired and configured in an essentially vertical arrangement of parallel cathode and anode plates. Horizontal placements and even cylindrical pairings may be appropriate for a given application and space constraint without varying from the overall spirit and scope of this invention. The electrodes 40 are physically attached to the Eco-Floc electro-coagulation system structure 35 and tanks by the electrode supports 64A. The electrode configurations are further discussed in FIG. 15 of the Operation section, below.

Another improvement of the instants Eco-Floc electro-coagulation system 30 is the manner of providing and controlling the electrical power source 60 to the electrodes 40. The source 60 of the electrical power is sized and designed to provide an appropriately configured alternating or direct electrical current to the electrodes. Commonly as shown here, for example and not as a limitation, the source 60 is AC power 60A that is then passed through a means to rectify 61 the power to Direct Current. The rectification would be under some controlling means 62. The actual designs of the transfer and control means 63 include many improvements over traditional designs through state of the art telemetry and control loops that effectively adjust the device to optimize the process. Once rectified, the current to the electrodes 40 would have a means to transfer and to control 63 the amount of the electrical power to the actual electrodes 40 for the electrolysis actions. An optional utilization of a nominal 24 VDC systems essentially may aid in lowering the total incoming power required while giving the system the much need treating power for even the most difficult applications. The overall electro-coagulation system 30 anticipates control and tuning for the voltage for the system in it preferred embodiment to range from approximately 1.5 to 30 volts, DC. A power transmission 63 delivery that utilizes PWM (Pulse Width Modulation) of 4 KHz primary with an amp monitoring S-Curve secondary delivery. This anticipates and provides a new control design concept that powers each cathode 41 and anode 42 thereby increasing the overall reaction chamber 55A efficiency of the design many times over the traditional powered and static plate design. Once transferred by the means 63, the current would pass on to the electrodes by a means 63A for connecting the source electrical power from the transfer and control means 63 and the actual electrode pairs 40. An alternative control means 63 anticipates one where the electrical control/delivery is actuated by pulsing the electrical delivery. The electrical pulse can be accomplished at high frequency (25 KHz to 250 Khz) as a means of increasing the overall efficiency of the electrolysis reaction.

Returning to the final exits of materials from the Eco-Floc electro-coagulation system 30 the essentially clear and clean water or liquid 75 is ready for use or disposal. As the water or liquid 75 is exiting, any remaining post heavy masses 59C drop through the heavy exit 80 in the bottom of the post treatment zone 69A. Once the heavies 59C exit they pass through the sight or view pipe 57, then through the exit valve 81 and optional check valve 81A. The post heavies 59C then may pass through the heavies exit 81B and on to the common heavies or solids retention tank 59D.

FIG. 4 A and the FIG. 3 repeated are sketches of an Eco Floc coagulation system 30 with the components and features shown together from generally a side 30B and top section view 30C. From the vantage of FIG. 4A, one sees the electrode pairs 40, the scraper 65, and scraper support 66A configuration. Also is shown the top section view 30C is the support structure 35 for the Eco-Floc electro-coagulation system 30. The view also shows the clear liquid exit 76 and head works influent liquid entrance 53A.

FIG. 5 is a larger sketch of the Eco Floc coagulation system 30 from a top section view 30C with components and features shown. The electrode pairs 40, the electrode supports 64A, and the scraper support 66A configuration is shown. Also is shown the top section view 30C is the support structure 35 for the Eco-Floc electro-coagulation system 30. The view also shows the clear liquid exit 76 and clear water 75. At the influent end, the head works screen 53 and the influent liquid entry 53A are indicated.

FIG. 6 A through 6 C are the Eco Floc coagulation system 30 with consecutive top views 30D and features shown. Notable a scraper blade section 65 and the means for scraping 64 are noted. The other features and components have been explained in other views above.

FIG. 7 A through 7 D are sketches of the Eco Floc coagulation system 30 from back 31, back section 32, end 34 and isometric 30E views with components and features shown. In FIG. 7 A from the back view 31 the clear water exit 76, the post treatment clear containment tank 76A and the heavies exit is shown to the left side of the drawing. On the right side of FIG. 7 A is the head works influent point 53A, the heavy solids and treatment tank 59A, and the heavies exit 59. Along the top area of FIG. 7 A is a means 91 for collecting and drawing the off-gasses (or brown, bio-gas) 90 produced in the treatment zone 55A from a headspace above the electrodes 40 of the Eco-Floc system 30. This collection includes a hood 91A and a Vacuum pull 92 on brown gas 90. The vacuum 92 pulls the bio-gas 90 from the hood area 91A and transfers the bio-gas 90 into a Holding Means 95 (a means for storing the off-gasses 90 of the system 30, said gasses consisting primarily of brown gas). FIGS. 7 B and 7 C show similar components from different viewpoints. Also, in these views are shown the electrode pairs 40 in the treatment zone 55A, the plate scrappers 65, the plate scraper support 66A and the scraper movement means 66 such as a motor or the like with connecting transmission means to the scrapers 65. FIG. 7 D shows an isometric view 30E of the Eco-Floc electro-coagulation system 30.

FIG. 8 A is an isometric view 30E with the components just described. FIG. 8 B is an isometric Eco-Floc electro-coagulation system with the outer surface containment removed to show the inner parts, as described herein. Both are sketches of the Eco Floc coagulation system 30 from generally isometric perspectives with components shown. A brief description of the brown or bio-gas 90 is as follows:
Biogas typically refers to a gas produced by the biological breakdown of organic matter in the absence of oxygen. Organic waste can be converted into a gaseous fuel called biogas. Biogas is a type of biofuel. It is converted from and produced by the anaerobic digestion or fermentation of biodegradable materials such as biomass, manure, sewage, municipal waste, green waste, plant and animal materials, and crops. Biogas comprises primarily methane (CH₄) and carbon dioxide (CO₂) and may have small amounts of hydrogen sulphide (H₂S), moisture and siloxanes. The gases methane, hydrogen, and carbon monoxide (CO) can be combusted or oxidized with oxygen. This energy release allows biogas to be used as a fuel. It can also be used in anaerobic digesters where it is typically used in a gas engine to convert the energy in the gas into electricity and heat. Biogas can be compressed, much like natural gas, and used to power motors. Biogas can also be cleaned and upgraded to natural gas standards when it becomes bio-methane. Biogas can be utilized for electricity production. Methane within biogas can be concentrated via a biogas upgrader to the same standards as fossil natural gas, which itself has had to go through a cleaning process, and becomes bio-methane. It may utilize the local gas distribution networks.

FIG. 9 A is an isometric view 800A and FIG. 9 B is a back view of an alternative embodiment 800 of a Eco Floc system 30 with rotating disk scrapers 806 between the coagulation plates 40. Both sketches show components similar to those already described above. In addition the rotating scraper axis 805 is indicated as well as its drive motor 810. Also shown are typical transmission lines 61 for the rectified power connecting to the electrode plate pairs 40. The alternative Rotating Disk Separator Electro-Coagulation System 800 is a continuous cleaning electro-coagulation system developed by Enviro Solve and utilizes rotating circular electrodes 40 with non-conductive scrapers 806 that clean each electrode surface (41B, 42B) on every rotation.

FIG. 10 A through 10B are front, side and top views of the alternative embodiment 800. The alternative system 800 has many of the inherent advantages including:
a heavy duty, robust industrial mechanical design; designs which include many improvements over traditional designs through state of the art telemetry and control loops that effectively adjust the device to optimize the process; a new design concept that powers each cathode and anode thereby increasing the overall reaction chamber efficiency of the design many times over the traditional powered and static plate design; a power transmission delivery that utilizes PWM (Pulse Width Modulation) of 4 KHz primary with an amp monitoring S-Curve secondary delivery; an optional utilization of a nominal 24 VDC systems which aids in lowering the total incoming power required while giving the system the much need treating power for even the most difficult applications; a continuous cleaning mechanism that not only removes the solids that adhere to the reaction plates, but also clears sludge “caking” and inert blockages a well; a way to capture the gases given off by the process giving the end user the ability to use the bio gas for other applications; an integration of the settling tanks with an agitator feed to the system to ensure a consistent treatment and adequate dwell time before dewatering the solids; and, an optional water misting system recycled from the processed side to help reduce foaming reaction and aid in cooling the electrodes.

FIG. 11 A through 11C are pictures of the prototype alternative rotating disc Eco Floc system 800. The components, features and advantages were discussed above.

FIG. 12 A through 12 D are design sketches 860 of the alternative rotating disc Eco Floc coagulation system.

FIG. 13 A through 13 F are pictures of a prototype 850 of the alternative Eco Floc Electro Coagulation system 30 with components and features shown. A sketch of the rotating scraper 806 is shown in FIG. 13 F. In FIGS. 13 B and 13 C the rotating axis 805 for the prototype 850 is indicated. Also shown is the means to rotate 810 the plate 806 such as a motor and chain, or equal. The ends or separators 45 of the scraper 806 are shown in FIG. 13 E. The scrapers 806, 45 are juxtaposed and situated between each electrode pair 40. In FIG. 13 D, the electrode pairs 40 are shown with the electrical power connections 61.

FIG. 14 is a chart 900 of the steps in the process of the Eco Floc Electro Coagulation 30. It is shown below in the operation.

FIGS. 15 A through 15 I are sketches of various components and explanatory slides for the Eco Floc Electro Coagulation system 30. FIGS. 15 A through 15 E are describing the operation and are discussed below in the operations section. FIG. 15 F is a top view of the treatment zone 55A and shows the electrodes 40. Here the anode 42 and cathode 41 plate pairs are separated by the scrapers 65. The scraper support 66A is also shown supported by the tank 59A and Eco-Floc structure 35. The scraper plate 65 movement 65A is indicated by the “arrow”. In FIG. 15 H this top view of 55A is enlarged and shows the anode 42 and cathode 41 on the support system 66A. In FIG. 15 G a side view and section show the anodes 42 and cathodes 41. The plate means 66 to move is also demonstrated. This was described above. Surface of the electrode pairs 40 are also indicated—anodes 42B and cathodes 41B. The scrapers 65 move past the surfaces 41B, 42B and remove any flocculants and materials to keep the reaction surface free for electrolysis to be more efficient. Finally, in FIG. 15 I, the anode plates 42 are shown with the surface 42B and the mounting slots 42A. These slots 42A permit easy removal and replacement of the sacrificial anodes to enable less down time of the Eco-Floc electro-coagulation system 30 for maintenance. The overall description of the electrode pairs and separator scrapers permit the configuration to yield a much higher current density and a controllable plate separation. All-in-all this permits a higher efficiency of the electrolysis.

More description of the components are shown below in the operation section. However, it is appropriate and helpful to address the various potential durable materials with which to manufacture the components of the Eco-Floc electro-coagulation system 30. The obvious steel and various steel alloys are anticipated as well as other metals such as aluminum. These will be coated or plated for resistance to corrosion and for wear resistance. Coatings can range from simple paints, powder coating, various electroplating or composite materials clad to the work surfaces. In addition, the structures may be comprised of composite materials such as urethanes, plastics and other durable materials. As discussed above, the structures 35 may be of various structural cross-sections. The electrodes are directly related to performance and are addressed below.

The details mentioned here are exemplary and not limiting. Other specific components and manners specific to describing a preferred embodiment of the special electro-coagulation system to remove contaminants and solids from a continuous flow and volume of wastewater and water solutions may be added as a person having ordinary skill in the field of electro-coagulation systems and devices well appreciates.

### OPERATION OF THE PREFERRED EMBODIMENT

The Purpose and Utility of the Eco-Floc electro-coagulation system 30 provides for the separation of solids, suspended and to a lesser degree dissolved, from challenging liquid wastes. The system achieves outstanding separation and disinfection through the creation of electrically induced physical and chemical reactions in-situ, creating clear, pathogen-free water and hydrophobic solids that can be readily removed through any traditional means of physical separation. The Eco-Floc system is self-cleaning and applicable to a wide array of liquid wastes ranging from raw animal wastes from confined feeding operations, to industrial wastes containing dissolved sources of biochemical oxygen demand. The various applications and some examples of use are shown and described below. One or more of the special electro-coagulation systems may be installed as new and original equipment option or an add-on system in various industries and situations that require removal of contaminants from a wastewater stream.

The Eco-Floc electro-coagulation system 30 utilizes a process to convert the impurities and dissolved metal contaminates to suspended particles where upon the dissolved gases help the suspended particles rise to the waste fluid surface to facilitate the contaminants to be removed or separated. The system and process are used for the treatment of various types of liquid streams by electrolysis for the removal of undesirable substances from a treatment stream. Particularly they are for cleaning the waste water by utilizing an electro-coagulation process to change the particle from in solution to a particle in suspension which can be flocculated and separated from the water.

The Eco-Floc Advanced Electro-coagulation Liquid Waste Treatment System 30 utilizes moving non-conductive scrapers 65 located between electrodes 40 so that the movement 65A of the scrapers can clean each electrode surface 41B, 42B. The system also has full electrical controls to “tune in” the removal of specific impurities. The sacrificial anodes 42 (part of the electrode plate pairs 40) are easily removed and replaced by means of a slot 42A at the plate top section. The slots 41A may rest onto the plate supports 64A. Currently the cathode plates 41 are secured directly to the supports 64A with slotted features. The applications of the Eco-Floc system 30 and associated process anticipate a plethora of materials and applications and adapts well both to existing operations as well as entirely new installations.

The technology allows for the energy efficient separation and removal of dissolved solids, metals and impurities from wastewater and other liquids. The system 30 uses electro-coagulation through chemical electrolysis by the electrodes to the waste stream as it passes.

The Eco-Floc electro-coagulation system 30 has many features and performance capabilities. Specifically the system allows for:
The processing of higher solids content than any other EC system available due to the Self-cleaning feature;
The capture of greater than 99.7% of total solids from raw dairy waste;
Greater reductions in BOD and COD from 84% to greater than 98% depending on the waste type;
Greater than 99% reduction in bacterial population;
Conversion of most intracellular water to free water allowing better dewatering;
Replacement of polymers at a lower cost for most applications;
Removal of heavy metals as oxides that pass TCLP;
Removal of suspended and colloidal solids;
The break-down of oil emulsions in water;
Removal of fats, oil, and grease;
Removal of the complex organics; and
The destruction and removal of bacteria, viruses & cysts.

For the Eco-Floc system 30 there are many applications and uses on various liquid waste streams to remove contaminants, impurities and dissolved solids. Some examples anticipated are listed to demonstrate potential uses. This listing is exemplary and not limitations to the system 30. For example, the Eco-Floc electro-coagulation system 30 can be applied for highly energy efficient removal from a wide variety of materials including but not limited to:

| Item | Application |
|---|---|
| 1 | Dairy wastes over the full range of solids content |
| | reported for the waste collection methods widely |
| | employed at large dairies |
| 2 | Other high-concentration animal feeding operations |
| | (CAF0s) |
| 3 | Glass Grinding Industry - glass fines separation - |
| | increased water recycling |
| 4 | Thin stillage separation at corn ethanol plants for |
| | energy savings and increased water recycling |
| 5 | Stone (granite, marble, etc.) Cutting/Grinding |
| | Industry - stone fines separation - increased water |
| | recycling |
| 6 | Vibratory Finishing Industry - fines separation - |
| | increased water recycling |
| 7 | Contaminated Groundwater & Surface Water Treatment |
| 8 | Raw sanitary waste treatment systems including also |
| | Combined Sewer Overflow installations |

FIG. 3 is a sketch of the Eco Floc coagulation system from a side section with input and output features shown. It demonstrates the various components. The basic process is as follows:

1. Provide Waste 100;

2. Pretreat 200;

3. Electro Coagulate 300;

4. Remove Solids 400; and

5. Post Operate on Solids 500

FIG. 13 A through 13 F are pictures of a prototype of the alternative Eco Floc Electro Coagulation system 30 with components and features shown. The pictures in FIGS. 13 D and 13 E show the electrode plates 40 up close and enable one to see how the scrapers 805 [and 65] are juxtaposed between each of the pairs of the electrodes 40. Likewise the ends 45 of the scrapes clear the ends of the electrode plates 40 and enable the material flocculants and other inerts to be urged and scraped from the surfaces 41B, 42B of the plates 40.

FIG. 14 is a chart of the Eco Floc Electro Coagulation method or process. The description of the steps in the Process for Eco-Floc electro-coagulation system 30 are shown as:

| | |
|---|---|
| I. | PROVIDE WASTE |
| | A WASTE |
| | B COLLECTION PIT |
| | C PUMP |
| | D GRIND(OPTIONAL |
| | E SCREEN(OPTIONAL) |
| | F CONVEY TO PRETREAT |
| II. | PRETREAT |
| | A DIVERSION BAFFLE |
| | B Add chemical enhancements(OPTIONAL) |
| | C SETTLE HEAVIES |
| | D COLLECT HEAVIES |
| | 1. VALVE |
| | 2. CHECK |
| | 3. PUMP |
| | 4. HOLD |
| | 5. PROCESS |
| | E CONVEY TO ELECTRO-COAG |
| III. | ELECTRO-COAGULATE: PLATE ELECTROLYSIS |
| | A PROVIDE PLATE |
| | B CHARGE PLATES |
| | 1. AC POWER |
| | 2. DC RECTIFY |
| | 3. CONTROL |
| | C REMOVE RESIDUE |
| | 1. PROVIDE SCRAPERS |
| | 2. OPERATE SCRAPERS |
| | D COLLECT BROWN GAS |
| | 1. HOOD GATHER W/VACUUM |
| | 2. VALVE |
| | 3. COLLECTION MEANS |
| | 4. PRESSURIZE |
| | 5. HOLDING MEANS |
| | 6. USE |
| | E COLLECT FOAM |
| | 1. SKIM FOAM |
| | 2. OUTPUT TROUGH |
| | 3. COLLECT |
| | 4. SOLIDS PROCESS |
| | F CONVEY TO SOLIDS REMOVAL |
| IV. | REMOVE SOLIDS |
| | A DIVERS ION BAFFLE |
| | B COLLECT FLOCCULANTS |
| | 1. VALVE |
| | 2. CHECK |
| | 3. PUMP |
| | 4. HOLD |
| | 5. CONVEY TO POST OPS |
| | C CONVEY CLEAR SOLUTION |
| V. | POST-OPS SOLIDS |
| | A PRESS |
| | B PYROLIZER |
| | C STEAM BOILER |
| | D TRUCK AWAY |
| | E OTHER |

FIGS. 15 A through 15 I are sketches of various components and explanatory slides for the Eco Floc Electro Coagulation system 30. FIGS. 15 F through 15 I were described above. FIG. 15 A shows a way to group more than one Eco-Floc electro-coagulation system 30 into a multi group array 895. This permits the system 30 footprints to remain small and still get higher capacities for a given application. FIG. 15 B shows the various ways that molecules form during the molecule physical convergence 890. The molecules may flocculate due to electrolysis or chemical additives; they may coalesce like in colloidal masses; they may “cream” and come together in groups lighter than the remaining liquid and float to the top surface of the liquid; or they may converge into a heavier mass and fall through gravity toward the bottom of the liquid as sedimentation. In FIGS. 15 C and D, the electrodes for electrolysis are demonstrated. Here the Electrolysis of the liquid requires excess energy in the form of over potential from the electrical power to overcome various activation barriers. Without the excess energy the electrolysis would occur very slowly or not at all. The efficiency of electrolysis may be increased through the addition of an electrolyte (such as a salt, an acid or a base). Careful selection of the reaction tank material is essential along with control of the current, flow rate and pH. Electrodes can be made of iron, aluminum, titanium, graphite or other materials, depending upon the wastewater to be treated and the contaminants to be removed. Temperature and pressure have little effect on the process. FIG. 15 C is a diagram of a copper cathode in a galvanic cell (e.g., a battery). A positive current i flows out of the cathode (CCD mnemonic: Cathode Current Departs). A cathode is an electrode through which electric current flows out of a polarized electrical device. Mnemonic: CCD (Cathode Current Departs). FIG. 15 C is a diagram of a zinc anode in a galvanic cell. Watch how electrons move out of the cell, and the current moves into it. An anode is an electrode through which electric current flows into a polarized electrical device. Mnemonic: ACID (Anode Current Into Device). (The direction of electric current is, by convention, opposite to the direction of electron flow). Cathodes and anodes are discussed further in the attached addendum. In FIG. 15 E the EC process the water-contaminant mixture 48 separates into a floating layer, a mineral-rich sediment, and essentially clear water 75. The floating layer is removed by means of a patented overflow/removal method, and moved to a sludge collection tank. The aggregated mass settles down due to gravitational force, and is subsequently removed through a drainage valve at the bottom of the EC reaction tank, and moved to a sludge collection tank. The clear, treated water is pumped to a buffer tank for later disposal and/or reuse in the plant's designated process. This overall tuned-in electrolysis provides a waste treatment system that achieves outstanding separation and disinfection through the creation of electrically induced physical and chemical reactions in-situ, creating clear, pathogen-free water and hydrophobic solids that can be readily removed through any traditional means of physical separation.

It may be helpful at this point to also understand the power to the Eco-Floc system and the resultant efficiency. The Eco-Floc requires amps in order to treat the waste stream. If no amps are being consumed the water is already too pure for an effective treatment. Preferably, only an Eco-Floc technician should test and determine if the Eco-Floc system is right for the end user application. The Eco-Floc Electro-coagulation technology features the first automatic mechanical self-cleaning electro-coagulation system combining state of the art electrical control technology with a heavy duty, robust industrial strength mechanical unit designed for a wide variety of new wastewater treatment applications. By the proper tuning of power to the electrode plates, the Eco-Floc systems can efficiently reduce containments in the waste streams by coagulating and increasing solids mass in order for simple mechanical separation to capture and de-water waste that would normally pass through mechanical separation. Eco-Floc is most effective when a screening device and/or centrifuge are positioned upstream to the treatment zone to remove the heavy solids loading. Next the centrate from the first phase of separation would pass through the appropriate Eco-Floc system for finer solids removal. A loop back from the Eco-Floc system output to the centrifuge may be used for second phase separation and de-watering of the solids if needed or desired. When the Eco-Floc system is configured properly the system 30 can reduce the TSS value to obtain essentially 99.9% pure water. Important to note is that not all waste streams achieve this purity on a single pass. Eco-Floc systems, like some other EC devices, employ the use of sacrificial electrodes and eventually these electrodes will require replacement. With the Eco-Floc electro-coagulation system 30, the anodes 42 have convenient slots 42A for support by the electrode system supports 64A, as shown in FIG. 15 I.

With this description it is to be understood that the preferred and alternative embodiments, applications and uses of the special Eco-Floc electro-coagulation system 30 are used to convert the impurities and dissolved metal contaminants to suspended particles to then be removed or separated. The system and process are used for the treatment of various types of liquid streams by electrolysis for the removal of undesirable substances from a treatment stream. It is a continuous cleaning system. It utilizes moving, non-conductive scrapers located between electrodes so that the movement of the scrapers can clean each electrode. The system also has full electrical controls to “tune in” the removal of specific impurities. The sacrificial anodes (electrode plates) are easily removed and replaced. Eco-Floc electro-coagulation system is not to be limited to only the disclosed embodiment of the electrocoagulation system. The features of the preferred embodiment of the special system 30 are intended to cover various modifications and equivalent arrangements included within the spirit and scope of the detailed description and operation of the system presented in the above paragraphs and the accompanying drawings.

1. A continuous cleaning electro-coagulation system made of durable materials and comprised of
a. A means (51) for conveying a liquid waste (50A) into the Eco-Floc system (30);
b. A means (56) for collecting and conveying pre-treatment heavies (59B);
c. An electro-coagulation treatment zone (55A), consisting of at least one pair of electrodes (40) with opposingly faced reactive surfaces, through which, said liquid waste (50A) will pass between;
d. A means (64) for scraping the electrodes (40) on a continuous or intermittent basis, to keep the reactive surfaces of the electrodes (40) clean;
e. A means (70) for conveying by which the treated liquid waste (69) exits the treatment zone (55A);
f. A means (70B) for collecting and conveying any floating solids in the exit zone (69A) of treated liquid waste (69);
g. A means (80) for collecting and conveying any post treatment heavy solids (59C) in the exit zone (69A) of treated liquid waste (69);
h. A receiving vessel (76A) into which the essentially clear treated liquid waste (49) flows without heavy or floating solids;
i. A source (60) of electrical power, which may provide an appropriately configured, as alternating or direct, electrical current;
j. A means (63A) for connecting the source (60) of electrical power and the paired electrodes (40), which may number from two to hundreds;
k. A means for transferring and controlling (63) the amount of electrical power delivered to the electrodes (40);
l. A means (91) for collecting and drawing the off-gasses produced in the treatment zone (55A) from a headspace above the electrodes (40) of the Eco-Floc system (30);
m. A means (95) for storing the off-gasses of the system (30), said gasses consisting primarily of brown gas (90);
whereby the electro-coagulation system treats wastewater and the system utilizes a group of moving non-conductive scrapers located between a pair of electrodes so that the movement of the scrapers can clean each electrode during the treatment of the wastewater.

2. The device according to claim 1 wherein the treated wastewater is from the group consisting of dairy wastes; high-concentration animal feeding operations (CAFOs); glass grinding industry; thin stillage separation at corn ethanol plants; stone cutting and grinding industry; vibratory finishing industry; contaminated groundwater and surface water treatment and raw sanitary waste treatment systems.

3. The device according to claim 1 wherein the means (64) for scraping is comprised of a plurality of non-conductive scrapers (65), a scraper support system (66A), and a movement means (66).

4. The device according to claim 3 wherein the movement means is from a group consisting of a motor and a gear drive; a motor and a belt drive; a motor and a chain drive; an eccentric linkage; and direct motor drive system.

5. The device according to claim 1 wherein the means (64) for scraping is a plurality of rotating disk scrapers between the coagulation plates.

6. The device according to claim 1 wherein the durable material of the system is from the group consisting of steel, steel alloys, non-ferrous metals, aluminum, composite materials, urethane, and reinforced plastics.

7. The device according to claim 5 wherein the durable material have coatings from the group consisting of simple paints, powder coating, and electroplating.

8. The device according to claim 1 wherein the means (70B) for conveying and collecting any floating solids is with a foam wheel, a trough and a foam collection tank transferring material to a common solid retention tank (59D).

9. The device in claim 1 wherein the means (91) for collecting and drawing the off-gasses (90) produced in a treatment zone (55A) from a headspace above the electrodes (40) of the system (30) is comprised of a hood (91A), a Vacuum pull (92) and a means for transferring the bio-gas 90 into a means for holding (95).

10. The device in claim 1 wherein the at least one pair of electrodes (40) with opposingly faced reactive surfaces are easily removed and replaced.

11. The device in claim 1 wherein the at least one pair of electrodes (40) with opposingly faced reactive surfaces are dual pairs (40) comprised of a sacrificial anodes (42) and a cathodes (41), all said pairs being located interior to the system (30).

12. The device in claim 1 wherein the source (60) of electrical power is in a range from approximately 1.5 to 30 volts, DC.

13. The device in claim 1 wherein the source (60) of electrical power is a power transmission (63) delivery that utilizes PWM (Pulse Width Modulation) of approximately 4 KHz primary with a means for amp/current monitoring

14. The device in claim 1 wherein the means for transferring and controlling (63) the amount of electrical power delivered to the electrodes (40) also has a full complement of electrical controls to “tune in” the system to the removal of a group specific impurities.

15. A process for an Electro Coagulation (30) called Eco Floc is comprised of:
STEP 1. Provide Waste 100;
STEP 2. Pretreat 200;
STEP 3. Electro Coagulate 300;
STEP 4. Remove Solids 400; and
STEP 5. Post Operate on Solids 500
whereby the electro-coagulation process is used to treat wastewater.
